(19) United States
(12) Patent Application Publication
(10) Pub. No.: US 2023/0325897 A1
(43) Pub. Date: Oct. 12, 2023

(54) METHOD AND PROCESS FOR VERIFYING VERACITY IN A CONTENT LICENSING REPOSITORY AND EXCHANGE PLATFORM

(71) Applicant: Thomas A. Dye, Austin, TX (US)

(72) Inventor: Thomas A. Dye, Austin, TX (US)

(73) Assignee: Veracify Media, LLC, Austin, TX (US)

(21) Appl. No.: 17/803,430

(22) Filed: Jul. 1, 2022

Related U.S. Application Data
(60) Provisional application No. 63/259,321, filed on Jul. 8, 2021.
(60) Provisional application No. 63/259,322, filed on Jul. 8, 2021.

(51) Int. Cl. G06Q 30/0601; G06V 20/40; G06V 10/40; G06Q 30/08

(52) U.S. Cl. CPC G06Q 30/0609; G06V 20/46; G06V 10/40; G06V 20/49; G06Q 30/08

(57) ABSTRACT

The present invention uses a novel method of using machine learning (ML) algorithms to train predictive models for content classification to spot bias, non-truths, miss-information and altered reality in publicly published media content. The predictive ML models automatically identify quality ratings, truth and honesty, content and site ranking, fact summarization and publishing history to quickly identify certain misinformation embedded within the media content. The purpose of the models is to quickly analyze and identify for the consumer when, where and what may have been altered or maybe misleading information in the content. Thus, independent of human positioning or bias, the present invention teaches one knowledgeable in the art how to build and deploy AI based models that independently rank and classify different published media. The invention uses a variety of novel methods along with methods of deployment to spot and identify where content contains personal opinions, third party human judgement, applied intentional bias and/or content positioning propaganda. Thus, the present invention uses various methods of machine learning deployed through software applications running on computing mobile or desktop devices for the purpose of restoring truth and honesty in worlds journalism, social media communications and advertising.

### CROSS REFERENCE

This patent application claims the benefit of provisional patent application 63/259,321 that was filed on Jul. 8, 2021 and entitled METHOD AND PROCESS FOR CHECKING MEDIA CONTENT VERACITY;

this patent application also claims the benefit of provisional patent application 63/259,322 also filed on Jul. 8, 2021, METHOD AND PROCESS FOR VERIFYING VERACITY IN A CONTENT LICENSING REPOSITORY AND EXCHANGE PLATFORM;

### FIELD

The present disclosure relates to a system and method that enables media content creators supply quality media content to media content buyers using an on-line exchange system platform. The exchange enables buyers to retrieve media content from creators and predict the probability of propaganda and misinformation prior to buying or licensing media content through the exchange. or positioning misinformation within the content prior to buying or licensing. Further, the system platform enables a method for media content sellers to screen material for embedded propaganda and misinformation prior to listing the media content for bids on the exchange. More specifically, the system and method enable content screening, content repository and smart contract features embedded within the exchange operations.

### BACKGROUND

Within the last few years publishers may have lost their ability to rank their publications for “truth and honesty” or “trust” in media content. Some of the issues relate to special interests and business revenue generated by advertising sponsorships, off-shore propaganda, political agendas. All these issues and more play off the ability more misleading media content to “program” consumers point of view to align with the messages pushed by such special interest groups. For example, media distribution companies have recently introduced various methods of gaining high emotional bias by altering the content messaging to fit one or more private agenda pushed by the network sponsors of one or more privately held (or foreign) organizations. The larger media syndication networks understand that miss-information and half-truths spark human interest, and in fact, sometimes the more outrageous the media content title, topic and/or content positioning, the more subscribers, or media content consumers they attract. Such propaganda is often believed as “truthful and trusted” by most of the consumer audience. Without a method to verify the veracity of the media content prior to market entry and content publication, the media market often provides no means to track changes, modifications, and derivatives, let alone original source providers or publication licensed owners of the media content.

Social media application suppliers and media networks have spent millions (if not billions) of dollars hiring human content scrubbers to remove misplaced hate, bias and fear-mongering that resides in network producer content. What they have found is that the human scrubbers and corporate positioning can introduce even more bias as they try to qualify, cancel memberships and/or filter content on their respective application platforms. This positioning, delivered by media syndicators and modern social media application technology, has split viewer opinion and slashed social unity to a point where social violence has become a big part of our modern-day society. The present invention teaches a system and method for the application of smart contracts platform through a public media content repository and exchange. The veracity exchange system and method as outlined herein contains the ability to automatically test and measure content veracity prior to making purchase and distribution transaction decisions. The use of block-chain technology has recently enabled the deployment of smart contracts enabling more transparency in the origin and legality of content ownership. The increased usage and the application of Artificial Intelligence (AI) and Machine Learning (ML) technologies help identify where and when certain types of propaganda are injected into media content. Further, the system and method analyze, detects and notifies users about hidden agendas embedded in media content such as false or misleading information in published content. The present invention as outlined herein may be used by content consumers, authors, publishers, advertisers, and content syndication outlets to ultimately trade, purchase, track and create transparency in the process of media content creation and distribution. The veracity exchange platform can be used to improve content quality, prior to publication and distribution, enabling the consumers to gain trust in media. The present invention has a purpose to help turn the trends of mistrust regaining audience confidence through propaganda identification and notification increasing honesty and transparency in media content.

### SUMMARY

The system and method of the present invention describes the use of a veracity engine method and process to enable media content veracity checking as a component of a media content exchange platform. the media content exchange platform, also called the “veracity exchange” or “I-HUB platform” enables media content creators and content sellers, to transfer ownership or be licensors of their media content to media content buyers or media content licensees. The I-HUB platform enables exchange (transactions) of ownership, licensing contract management, market evaluation, and media content veracity qualification to enable publication and distribution of high quality “trusted” media content. In the preferred embodiment of the present invention a method for media content storage and retrieval, defined herein as the “repository engine” is described. The veracity exchange platform is preferably deployed as an on-line application where platform users connect through a plurality of client devices. The method described herein uses one or more Machine Learning (ML) methods to determine and identify the probability of propaganda, media content provider positioning, and misinformation embedded within a plurality of media content stored or referenced by the repository engine. The method enables providers of media content the smart tools and contracts needed to secure ownerships, licensing, and content distribution rights. The present method also provides the ability for content providers to pre-market test their media content, estimate and flag veracity concerns and exchange ownership through the veracity exchange's automated bidding auctions. Thus, media content consumers, creators, authors, publications, and distribution channels can help ensure that media consumers get high quality, transparent media content that their respective audiences can trust, strengthening trust between media consumers and media providers.

### FIGURES

The present systems and methods will be more fully understood by reference to the following drawings which are presented for illustrative, not limiting, purposes.

FIG. 1 shows an illustrated high-level system flowchart of the major computational blocks of the present invention.

FIG. 2 shows an illustrative flowchart for a client device and compute cloud data fetch and store process from qualified endpoints.

FIG. 3 shows an illustrative flowchart for a method used to download, store and process similar media content.

FIG. 4 shows an illustrative flowchart for an audio/video stream extraction process to convert media content into one or more standard text files.

FIG. 5 shows an illustrative high-level flowchart for the compute blocks that make up the veracity engine pipeline of the present invention.

FIG. 6 shows an illustrative method to determine bias and lean from crowd sourced responses to analyzed media content.

FIG. 7 shows an illustrative method to train a fact checking machine model using aggregated media from third-party fact checkers.

FIG. 8 shows an illustrative flowchart for the programming of the user interface and application software process flow.

FIG. 9 is an illustration of the programming blocks for the method of the I-HUB media Content Exchange invention.

FIG. 10 illustrates an example of a typical use case for the process flow for the method of FIG. 9.

A computing device or system may be used to carry out certain program steps as illustrated in the representative figures above. The present embodiment of illustrative figures shows one possible method and process of program code that runs on one or more computing devices to carry out a method of implementing the I-HUB Veracity Exchange platform, along with the defined supporting application system and methods according to some embodiment of the present invention.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the systems and methods described herein may vary as to configuration and as to details. The following detailed description of the illustrative embodiments includes reference to the accompanying drawings, which form a part of this application. The drawings show, by way of illustration, specific embodiments in which the invention may be practiced. It is to be understood that other embodiments may be utilized, and structural changes may be made without departing from the scope of the claims. It is further understood that the steps described with respect to the disclosed process(es) may be performed in any order and are not limited to the order presented herein.

A veracity exchange platform and its associated system and methods are disclosed. Wherein, the veracity exchange utilizes one or more Artificial Intelligence (AI) components using trained Machine Learning (ML) models to estimate and point out Media Content Veracity. Media Content, “MC” or “content” may be in one of many formats including but not limited to: printed publications, Internet web-sources and site information, streaming media consisting of audio, video or both, broadcast and syndicated network information. In the present embodiment the term “End-User” is synonymous with “User”, or “Consumer” or “Seller” or “Buyer” or “Subscriber” or “Exchange Member” in which, and per this specification, may be represented in singular or plural form to have the same meaning. The term “End-User” may be defined as anyone, group or any program application acting as a user under the management by someone or by group, which has sign-on credentials and access to the veracity exchange platform. The method of the veracity exchange may use multiple forms of AI and ML programming for veracity analysis component, including but not limited to; time-line analysis, group and peer reviewing, end-user ratings, similar content analysis, content bias and lean analysis, topic summation and segmentation analysis, opinion and positioning analysis, author and publisher reviews, entity, sentiment, and entity-sentiment analysis. The purpose of the veracity exchange and associated veracity engine pipeline of the present invention is to provide trust and transparency between media content providers and consumers by identification of areas within the content where propaganda may exist.

Without limitation, the method of the veracity engine pipeline also identifies areas within the content of; misinformation, missing information, bias, lean, statement positioning and other specifically structured propaganda representation methods which are typically embedded within a plethora of media content. As such, the term “propaganda” may be used in this specification to represent a “catch-all” term that represents all the content mistrust components listed above. Propaganda in media content is typically used to persuade at least one member of the consuming audience “Consumers” to align with one or more desired positioning statements of one or more the Media Providers. Without limitation, and for the context of the present invention, “Media Providers” or “Providers” may include but not limited to; authors, advertisers, syndicated or non-syndicated news sources, independent authors, public and private publications, syndication networks outlets and various types of other media networks. The present invention uses one or more Machine Learning methods to determine the probability of propaganda such as misleading content or provider positioning misinformation within content. One method of propaganda identification includes first collecting web-links pointing to similar or related content and second, processing the content endpoints of such links preferably through the veracity engine of the present invention. The various related web-links are used to pull media content information, poll the audience, process, analyze and find other related content used to train the inventions predictive and deterministic ML Models. The ML models that subsequently make up the veracity engine's method and process pipeline consume a plethora of related content for extraction, analysis, using end-user notification of areas within media content where propaganda may exist. Thus, by exposing segments of provider hidden propaganda within media content to end-users, creators/authors, publication outlets and distribution channels, the disclosure herein of the present invention improves content transparency to assist with strengthening trust between content consumers and media providers.

The systems and methods described herein preferably operate in a cloud computing environment to enable media content classification, Media content ownership and licensing transactions between media buyers and sellers, and media content data repository storage and management. Media classification is performed using a system and method described herein called the Media Content Veracity Prediction Engine (aka, Veracity Engine). Additionally, the systems and methods import various data sets of media-based content from disparate sources, apply AI and/or ML to the data sets to create different analysis vectors for different domain types. The systems and methods described herein are used to optimize the consumer's ability to determine the likelihood if the content contains embedded propaganda or, is fishing for an emotional or reactive response. By improving the quality of media content providers and publishers alike can quickly identify media segments that are misleading, contain propaganda or bias and lean. The subscriber members of the veracity exchange can quickly click through identified red, yellow or green flags and receive additional information further outlining why the segments were flagged. The system and method described herein does not attempt to predict or declare content as fact or fiction, true or false information, but instead reports segments that are flagged for further possible review by the media content consumer. Thus, the system and method may be used by subscriber members of the exchange not only for buy/sell transactions but to quickly understand media content value, if the content can be fully owned or licensed and if there is similar or copied media content already published.

Generally, media content is supplied by a plurality of media content providers. Media content input components may include media content topic, topic domain or subject, publication timelines, missing or altered information, media format (i.e., Text, Pictures, Audio, Video), author and/or publisher reputation, publication volume, distribution methods, geographic location. These input components or “inputs” are all factors used in the analysis to determine content flags. The inputs may also be used as covariates, dependent and/or independent variables used to not only train the models but, are also the input data that generate predictive responses output by the veracity engine software pipeline. However, there are many other input variables that may be applied and are not mentioned herein, this list outlines the preferred inputs used by the present embodiment. These inputs form the major and minor input variables that feed the models that make up the veracity engine pipeline. Furthermore, the retrieved input components are used along with retrieved input “content components”, also called “input content components” or just “components” herein. Components are used as inputs for modeling and content analysis. Media components are analyzed for key media segments with specific attributes embedded in the media content. Along with the input components, content components are also used by the present method to perform sentiment analysis, entity and entity-sentiment analysis, similar content comparison analysis, bias, lean, opinion, content positioning and the like on provider media content. Input components along with content components contribute to the analysis results to determine which segments of the main media content are flagged for end-user notification.

The systems and methods presented herein are designed to identify certain anomalies (flags) that may normally not be observed in provider content. These anomalies are used by both author and publisher to improve media content veracity and thus to improve the quality of content. Additionally, the systems and methods presented herein utilizes one or more Artificial Intelligence (AI) frameworks using bootstrapped trained Machine Learning (ML) predictive models to estimate and identify content anomalies or flags as further described by this specification.

Provider media content, “MC” or “content” may be in one of many formats including but not limited to: printed publications, Internet web-sources and site information, streaming media consisting of audio, video or both, broadcast and syndicated network information. In the present embodiment the term “End-User” is synonymous with “User”, or “Consumer” in which, and per this specification, may be represented in singular or plural form to have the same meaning. Furthermore, by definition, the author, publisher or syndicated network provides media content to the consumer. The consumers of the content, typically one or more people who consume media content, consume media content in multiple data formats through one or more content publications, media networks or syndicated channels.

Further still, the method of the veracity exchange may use multiple forms of AI and ML programming to accomplish the veracity analysis and output responses. Including, but not limited to; supervised and unsupervised learning, reinforcement learning, artificial narrow intelligence, general and super artificial intelligence. Further still, the system and methods described herein may use one or more commonly used Machine Learning algorithms such as linear regression, logistic regression, decision tree, SVM, naïve Bayes, KNN, K-means and random forest algorithms to accomplish the veracity analysis.

Further still, the systems and methods described herein may use the term “propaganda” to represent a catch-all terminology that represents at least one of the content mistrust or misinformation attributes listed above. Embedded propaganda in media content is typically used to persuade at least one member of the consuming audience to align with one or more desired positioning statements from one or more the Media Providers. Without limitation, and for the context of the present invention, “Media Providers” or “Providers” may include but not limited to; authors, advertisers, syndicated or non-syndicated news sources, independent authors, public and private publications, syndication networks outlets and various types of other media networks.

Without limitation, the systems and methods of the veracity exchange platform and the associated veracity prediction engine, enables media buyers and sellers to identify areas within media content that are flagged for misinformation, missing information, information that has been altered or changed from the original content, bias, lean, statement positioning and other specifically structured propaganda representation methods which are typically embedded within a plethora of publicized media content prior to or during a purchase or licensing transaction.

The I-HUB platform introduces a system and method for media content exchange between media content providers and media content buyers. Media content providers create original works or provide publishing services that enable original media content to be published into a public or private marketplace. To accomplish the method the preferred embodiment encompasses several components including a “Content Exchange and Repository Engine” a “Veracity Prediction Engine” and a “Licensing and Digital Currency Exchange Engine” as defined herein.

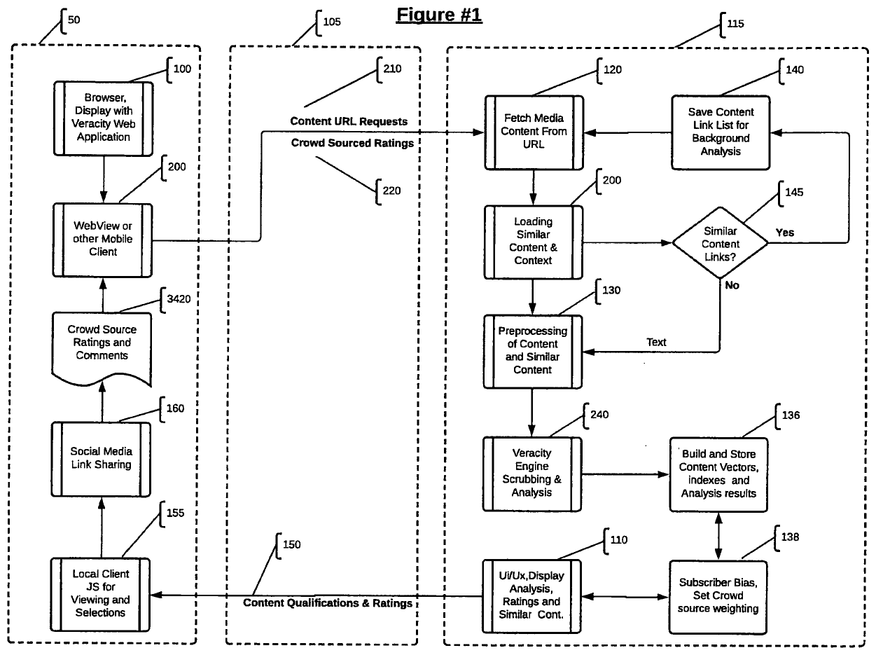

The systems and methods provide a veracity prediction engine that can be trained with ML to predict and set reference flags to possible misleading propaganda in media content. Referring to FIG. 1 there is shown an illustrated high-level system flowchart of the major computational blocks of the present invention. STOP

Referring to FIG. 1 block [50], an illustration of a method of the present invention running on one or more “client computing devices”, “client devices” or just “clients” is shown. In an embodiment, using a client computing device includes, but is not limited to, turning on the power, bringing up an operating system and/or associated applications, using a pointing device, using voice recognition, tapping or clicking operations or other means to initialize input commands and directive operations supported by the computing device. In an embodiment, using certain other input devices on the computing device may enable image and video capture, monotone or stereo audio input, video input and connections to wireless or wired interface networks. In an embodiment wireless or wired, Bluetooth or other network connections may be used to input or output digital streaming media, typically consisting of digital or analog audio, video, data, text, and imagery.

Use of a client computing device [50] may also include, but is not limited to, viewing display information from one or more output displays either on mobile computing devices, laptop computing devices, desktop computing devices or other miscellaneous display devices with internal or external connections to one or more displays. Using a client computing device may also include listening to audio from the client device directly or through external speakers, wireless or Bluetooth enabled speakers or other electronic devices designed to output audio, Television and video.

Client devices can be used to acquire, store, compute, process, communicate and or display information including, but not limited to, text, images, videos, and audio. In some embodiments, client devices can monitor information, process information, and check information to provide quality status or ratings of the information including a quality ranking of the information or of one or more information sources.

In general, a hardware structure suitable for implementing the program instructions on the client computing devices may be used to carry out the client usage for control and display of the inventions veracity engine analysis results which, may be local to the client computing device or remote in one or more computing centers, cloud computing facilities or on dedicated computing servers.

Again, referring to FIG. 1 a high-level illustration is shown of the major programming code running in different programming functions of one embodiment of the preferred system apparatus or “Platform” for the present invention. Client application programming, running on the client computing hardware, carry out various programming instructions for the present invention. The Veracity engine pipeline process [115] runs programming code on the back-end computing platform apparatus. The illustration of program code in FIG. 1 also includes at least one of the following: a network interface [105], a memory device or subsystem, a processor, I/O devices, a bus, a storage device including other platform computing devices as known to one knowledgeable in the art.

Again, referring to FIG. 1, an illustration of the present invention's programmatic pipeline is shown. The pipeline shows several high-level functional program code blocks including the client computing device [50]. In the preferred embodiment and without limitation, this client device may be one or more brands of mobile devices such as an iPhones or Android OS-based client device. Block [50] of FIG. 1 illustrates the downloaded program code also known as the application code of the present invention. Other program code such as the client operating system, user interface applications and client application execution and control code are not illustrated in FIG. 1 as this practice is known to those knowledgeable in the art. The client computing device [50] is typically enhanced with an installable web browser application and other various third-party software applications. The various client devices used by the preferred embodiment may have one or more Internet connections connecting to at least one back-end computing platform or back-end computer. In the preferred embodiment of the present invention, one or more back-end computers run the invention's Veracity engine pipeline as illustrated in FIG. 1, block [115]. The dashed lines of FIG. 1 represent one possible physical separation between the client computing device [50], the network interface [105] and the back-end computers [115] application programming. In the preferred embodiment, and again without limitation, the back-end computers are clusters of compute nodes typically running in a cloud computing environment. The dashed blocks [50], [115] as illustrated in FIG. 1 are typically separated by one or more Internet network connections used for communications protocols [210, 220, 150] between the clients and back-end computing clusters. The program code as represented by block [115] runs in the back-end computing clusters and is typically used for processing commands to fetch and process one or more data-formats of web content addressed by a plethora of URL endpoints [210]. The Web interface [105], additionally transports, using one or more network protocols, other client computing commands and information preferably between the Web-View based mobile client [220] and the back-end computing cluster [115]. Additionally, block [220] transports responses from crowd sourced ratings and may also contain other information such as similar article Universal Resource Locator (URL) pointers, or “media content pointers” used for additional referencing, processing and analysis by the back-end computing cluster [115].

The transport of data [150] from the back-end computing apparatus [115] to the client computing devices [50] may also include a plethora of content qualifications, content flags and content ratings for subsequent display on at least one client computing device. The multiple forms of media content analysis, also called content analysis, may be analysis of either the main media content or similar media content. The media content analysis is typically performed from the back-end computing cluster's veracity engine programming, block [240] within back-end computing block [115], with content analysis results typically displayed on the client computing device. Results from the media content analysis may include one or more data formats such as text, images, audio, video, and computer graphics.

Again, referring to the client computing device [50] of FIG. 1, the client computing device may consist of at least one of the following computer hardware components: computing or embedded micro processing unit, non-volatile memory, random access memory, solid state disk storage, digital display, removable storage, wired or wireless network, input/output (I/O) ports and I/O access devices as known to one knowledgeable in the art. Within the apparatus of the client computing device are certain programming codes running one or more of the programming functions used to accomplish the methods and process of the present invention. Program block [100] of FIG. 1 illustrates a typical browser application used as a User Input/User Execution (Ui/Ux) application interface to host application such as data delivered from the back-end computing apparatus or from veracity engine software programming. Additional application programming code such as WebView [200], a system level third party framework and other programming applications may be installed on the client device to support certain features and functions required by the veracity engine and associated web application programming. One such feature of the System level framework [200] is to transparently replicate and transport via block [105] user directed URLs (universal resource locators) to the back-end computing device [115] that subsequently are used to access and analyze the main or similar media content through one or more various Internet resources. Throughout this specification the term “main media content”, “original content” or “main content” is used to describe the media content that is currently under review for analysis as selected by one or more client device users. Client device users are also defined as “media consumers”, consumers or just users within this specification. While, “similar media content” is defined as content that has similarities to a certain degree with the main media content under analysis. Thus, one method of the present invention, without limitation, utilizes a framework such as WebView, or other third-party frameworks to echo to the back-end computing cluster the “main” media content URL and additional “similar” media content URLs for subsequent preprocessing and analysis by the veracity engine pipeline of block 115.

The Client Device [50] of the present invention preferably uses at least one media content URL pointer to fetch network content for display on the client device and then subsequently “echoes” URL pointers [220] pointing to that media content to the back-end computing cluster [115] through one or more public or private networks [105]. The client device uses resource pointers (or URL's) that fetch media content from network endpoints. Code block [120] uses the echoed URL address pointers to fetch the media content used for subsequent additional pre-processing and storage as illustrated in FIG. 1 code block [130]. The fetched media content may consist of both “main media” content and “similar media” content stored either in local or remote storage devices and further referenced by the back-end computing clusters. In the preferred embodiment, pre-processing of the main and similar content is performed to convert the bulk of the content to a format most readily used in preparation for veracity engine analysis. Thus, the main and similar content is first pre-processed and subsequently stored preferably in textural and/or image formats as known to those who practice the art.

In addition to fetching, storing, and processing the main media content, one or more “similar media” content topics may also be fetched, stored, and processed. Main and similar content components are based on audience interests and search selections typically from browser application content topic or reference search bar entries as illustrated in block [120]. In one embodiment the back-end computing cluster continuously seeks out similar content for further analysis and ML model training by the back-end computing cluster [115]. Loading Similar Content [200] from at least one network or storage device is typically a background process that spawns additional URLs pointing to the similar content as illustrated in FIG. 1, block [200]. Similar content may be stored and subsequently processed and analyzed [130] to determine the percent similarity and to what degree the similar content relates to the originally fetched, processed, and stored main content.

The programming of FIG. 1 block [145] determines, and may limit, how many similar content topics are available for comparison and further analysis. Similar media content topics are also archived by URL links and continuously fetched, stored, and processed typically running as a background task in block 115. Thus, media content referenced and fetched by the similar media content links are continuously pre-processed and analyzed and may be used for further analysis and ML model training. The similar media content, pointed to by the content link lists, must relate very closely to the main content topics to be considered as a source for further analysis and storage by block 115. The veracity engine determines the “percent likeness” of the similar content to the main content to create a “content similarity index”. The “content similarity index” is defined as a list of similar topics ranked by closest similarity proximity to the main media content topic and main media content market introduction that includes similarities to the main content and similar publication time-lines. Thus, the similarity index list shows the ranking and related content similarity to the main content by determining topics and time-line likeness and further assigns a similarity likelihood ranking score into the similarity index list. For the present embodiment, code block [140] builds and stores the list of similar media content URL links for the URL fetch module [120]. Once all the similar content is fetched or, if there are no more similar content links or, a limit of similar media content is reached, or other similarity criteria are reached, as determined by code block [145], the process continues to program code block 130 for additional pre-processing of the previously fetched and stored main and similar media content. Programming then continues by parsing the content into a list of content segment vectors as defined further below.

Furthermore, programming code illustrated by FIG. 1, block [140] pre-processes the different media content data formats to a common format, determines key content segments, and then packages the media segments into a series of content segment vectors. “Content Segment Vectors” or just “Segment Vectors” may be defined as a list of keyword and key-phase segments extracted from one or more main or similar media content blocks. Segment vectors are organized by topic, main content publication date, and similar content publication time-frames and may include content element types. Content element types, also called element types, are the sub-categories that define the type of propaganda to be identified. Examples of the element type sub-categories that identify propaganda and misleading information within media content are bias, sentiment, opinion, entities, names, keywords or key-phases and the like. Segment vectors are stored and indexed using at least one reference lists of pointers. The index list of pointers is ranked based on content segment vector importance. Content “segment importance rankings” are defined by weight or scalar attached to each propaganda element type and used to determine their relative importance to the analysis. Content segment vectors are used as one of the primary input sources used by the veracity engine for content analysis as illustrated in FIG. 1 block [240].

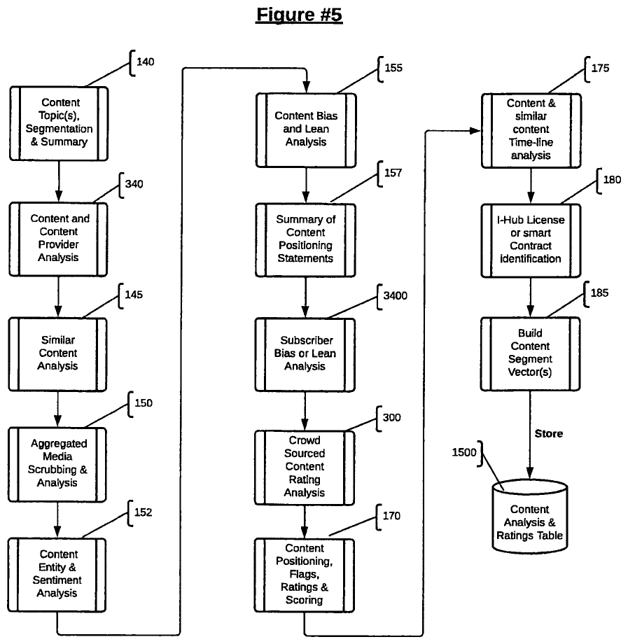

As further illustrated in FIG. 1 and detailed in FIG. 5, the veracity engine programming [240] contains multiple AI programming code blocks wherein, some programming blocks maybe based on ML training vectors. The programming of the veracity engine introduces methods used to analyze the previously pre-processed content segment vectors [130]. veracity engine programming [240] is used to scrub media content segment vectors for one or more indications of main and similar media content propaganda also known as the “veracity indicators”. Output results from programming block [240] are also known as the “veracity indicators” as described further in detail below. Programming block [136] takes the output veracity indicators from the veracity engine [240] and parses each veracity indicator into an indexed set of veracity indicator output vectors. The set of resulting parsed veracity indicator output vectors are subsequently stored for additional filtering by one or more output weighting functions as illustrated in program code block [138]. In an embodiment the veracity indicator output vectors may be filtered by the weighted results from other modules such as the user bias and sentiment analysis programming block [138] to produce one or more output responses as described in detail below.

Again, referring to FIG. 1, the output from the cloud computing cluster [115] informs the application user of at least one of many analyses output results from the veracity engine [240]. Programming code block [110] performs the final post-output processing of the final main media content analysis summary in preparation for network transport [150] and display output [155] on the client device [50]. Thus, the code block [110] may reformat any content qualifications and ratings based on the output results of the veracity engine in preparation for transport [150] and Ui/Ux processing in further preparation for output display on one or more client devices [50].

Prior to receiving main media content analysis of veracity qualifications and ratings from the back-end computing cluster, the client device has preferably downloaded and installed the client-side application software in a separate download and installation operation known to those in the art. Preferably, for the preset embodiment, and without limitation, one such component of the installation may be at least one client-side interpreter such as a JavaScript interpreter. As illustrated in FIG. 1 block [155] the interpreter is used for application client-side operations, sometimes referred to the application “Front-End” used for viewing information and/or hearing audio and display of graphics and images on the client device [50] display and sound output hardware.

Programming code in block [160] of FIG. 1 illustrates the programming used within the client devices to share media content links and veracity engine analysis results to other friends and associates through social media networks, network syndicators, user groups, individuals, and other portals with interested audiences. Share of content and veracity engine results links are enabled by tapping or selecting icons that represent share links to other applications as known to those knowledgeable in the art. In one embodiment a share link may be another form of sharing analysis results such as an email or text message also known to those knowledgeable in the art.

In addition, code block 3420 of FIG. 1 allows for crowd sourced ratings originating from one or more client devices as a “polling and content review mechanism” for the user audience. The polling mechanism is a method of the present invention to allow the audience to participate in the predictive results output from the veracity engine. According to the present embodiment, the polling operation and content review method enables consumers to rate and review both media content and analysis such as qualifications and rating results from the veracity engine. As an example, by enabling a plethora of crowd sourced information and responses pertaining to the main or similar media content, recommendations, comments and/or criticisms may also be captured and processed for future analysis improvements of subsequent main or similar media content. In an embodiment, crowd sourced responses may be indicated by “liking” (or “not-liking”) both media content and/or the veracity engine analysis results. Crowd source information [3420] thus becomes a part of the input sources coming from one or more client devices [50] which, is subsequently transported as crowd sourced ratings [220] to the back-end computing cluster.

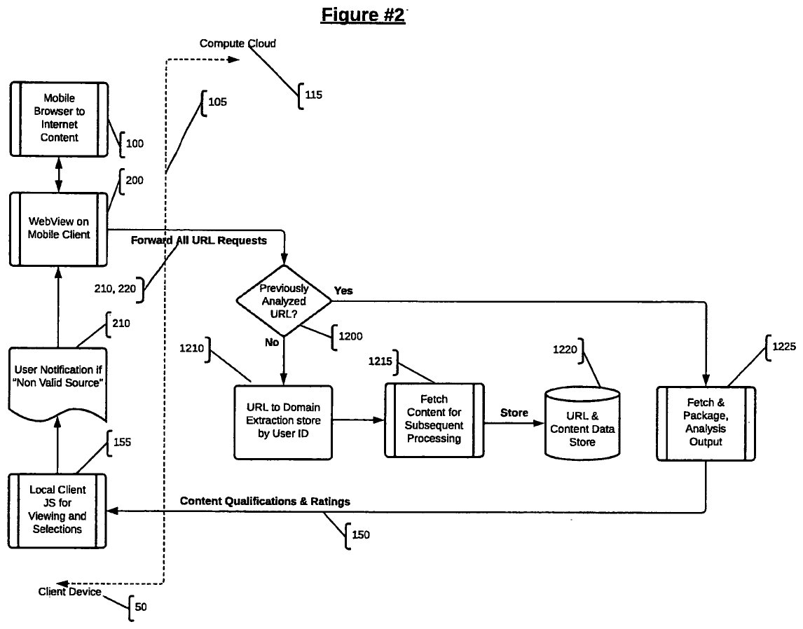

Referring now to FIG. 2, detailed programming code for fetching media content of illustrated in FIG. 1 block [120] is further illustrated. Illustrated in FIG. 1, the client devices [50] transport all resource pointers [210, 220] via network transport [115] to one or more back-end computing devices [115] for further URL qualifications by programming blocks illustrated in FIG. 2. Block [1200], processing blocks [1210, 1215] and storage block [1220] are illustrated. Block [1200] of the program code illustrated in FIG. 2 searches the URL and Content source table [1220] for the previously fetched and analyzed main or similar media content that may be previously stored as content segment vectors or fully analyzed veracity indicators into one or more URL and Content Source tables [1220]. If the programming flow FIG. 2 block [1200] determines that one or more content topics (addressed by media content URL pointers) has not been pre-processed and analyzed by the veracity engine [240] pipeline, then code block [1210] determines and extracts the domain name, fetches, and pre-processes the content [1215] and stores the results into at least one application database table categorized by the application username or other end-user identification.

Again, referring to FIG. 2 the programming at block [1215] illustrates where the qualified URL pointers are used to fetch the actual media content for further processing and storage. If fetched content is of the textual and/or image data format, the fetched media content referenced by the URL pointers is stored directly to the URL and Content storage device [1220] or alternatively to other storage devices as known to one knowledgeable in the art. In one embodiment if the fetched content is in the form of streaming media, typically in audio and/or video format, at least one additional step of “media decomposition”, segmentation and reformatting is required prior to content storage. Wherein media decomposition is defined as the process of converting streaming media like audio, video and possibly graphics into indexable text files that that contain streaming media meta data describing the context around the meaning of the stream. FIG. 2 programming block [1200] determines if veracity indicators exist from previously processed main or similar media content. To determine if a match exists the method compares a limited set of the main content attributes to determine if the newly fetched attributes match any sets of main content attributes already stored in the URL & Content data store tables [1220]. If there is not match, or previously analyzed and stored veracity indicators already built and stored [1220] the URL and Content data store tables may be updated, and a new analysis task is assigned to the veracity engine pipeline. If there are previously analyzed veracity indicators, built from main or similar media content [1200], the process continues by fetching the previously calculated veracity indicators that contain media content qualifications and ratings. The method continues by packaging the previously calculated output responses and information in preparation for transport [105] and eventual output display [155] on at least one client device [50].

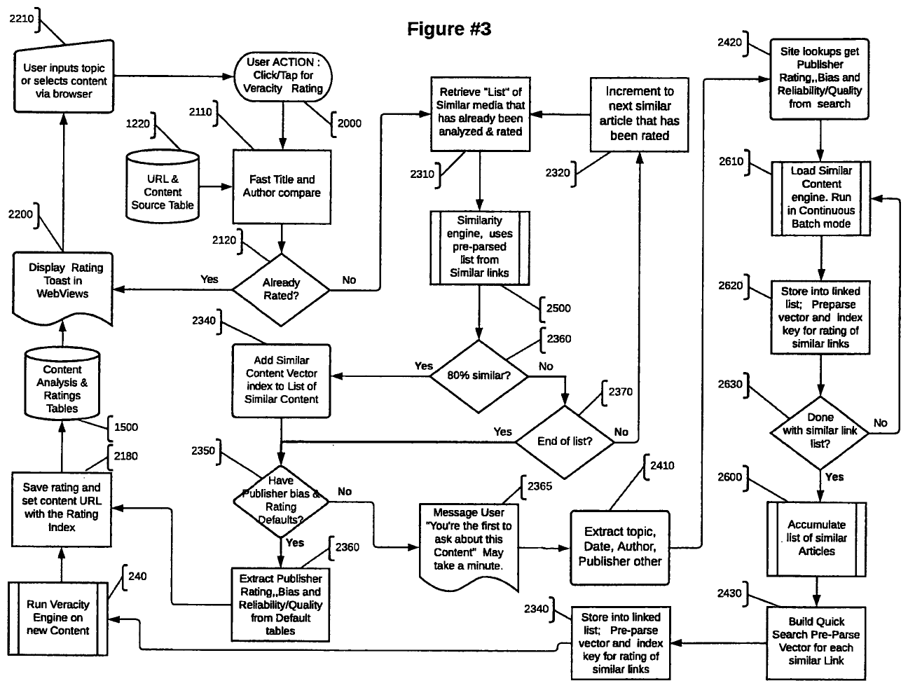

FIG. 3 illustrates the programming blocks and process flow for the determination of media content that is “like” or “similar” to the main media content that may or may not have been previously analyzed. The basis of the method shown in FIG. 3 illustrates the real-time analysis and rating process flow and how the present invention may handle previously analyzed media content. In addition, FIG. 3 shows how the method of the present invention determines similarity and handles non-analyzed media content that has not previously been analyzed and/or processed by the veracity engine pipeline [240]. The programmatic flow shown in FIG. 3 may be implemented with programming blocks of the preferred or any other comparable apparatus and without limitation, may run the program code on other client devices or back-end computing systems as known to those of the art.

FIG. 3 is further detailed with programming block [2210] wherein, the client device under direction of the application user requests may enter a search topic or select media content topics by tapping a media content subject of interest. Without Limitation of the present invention, this user action may be performed using one or more client device applications such as an Internet browser running on at least one client device. In an embodiment the media selection may be from one or more applications previously downloaded and installed or other application software running on at least one client device.

The program code in FIG. 3 continues with block 2000 typically running on one or more client devices and assumes the application user selects one or more main media content topics for subsequent veracity engine processing and analysis. The “Content Topic” may be defined as the main subject matter of the information within at least one subject domain spaces. For example, if the subject domain is animals, the content topic may be about how to take care of pets. In one embodiment the entire application may be for a separate domain, such as politics, crypto currency, or the like. By choosing an “application domain”, the scope of the vast amount of analysis can be narrowed to improve performance and reduce implementation complexity.

For the preferred embodiment of the present invention, it may be assumed that the veracity engine client software application has previously been downloaded and installed on a client device [50]. In alternate embodiments, by example and not limitation, the Browser application, or other applications such as WebView may be used to inject graphical user interface directives that enable veracity engine analysis software to run without previous full client application installation.

Continuing with block [2110] the programming quickly compares content titles and topics between the fetched main media content and previously stored similar media content. In the case of code block [2110] the similar media content has already been formatted, pre-processed, analyzed and stored. In one embodiment, a plethora of similar media content is processed similarly to the main content. Programming may run on either a client device, within one or more back-end computers, fully in one or more cloud compute platform services, or on other computing devices. As illustrated in FIG. 3 block [2110] the method preforms a “quick content compare” using media content and extracted content. The media content being compared may be defined as the comparison between one or more stored “main content attributes”. Main content attributes, used for comparison may include main topics, content titles, content authors, publishers, time-line information, other relevant identifiers, and the like. Content compare may use stored media content attributes from a segment attributes table termed a URL and Content Source Table [1220]. Main segment attributes, also termed just segment attributes may come from the fetched media content pointed to by the selected main media URL pointer. Using a media content compare process, the method looks for not just previously analyzed similar content but also looks for the exact same content assuming one or more application users selected main media content that has previously been analyzed by the veracity engine pipeline. The content compare method compares one or more segment attributes from the fetched media content with the same attribute class previously stored in the URL and Content Data Storage block table [1220]. The content attribute class may be defined by different classes of topics and/or subjects identified by content title, creation date, published date or other attributes that either accompany or are embedded within the content. The quick content compares, preferably and without limitation, determines of the media content of interest has already been analyzed. Previously analyzed content preferably is stored in the URL & Content Source Table [1220] that typically includes the main segment attributes.

The process continues with code block [2120] shown in FIG. 3 wherein segment attributes may be quickly extracted from the newly fetched main media content and compared to existing, previously stored, media segment attributes. The matching process preferably starts by indexing top level extracted attributes preferably content title, author, publisher and/or media content publication date. If the content attributes determine a possible matching content a more extensive matching may conclude an exact match and/or determine a match based on a threshold of matching attributes. If a matching determination is made [2120] the process continues with a fetch of the most recent analysis results for subsequent and immediate display [2200] typically on the client device [50] as previously outlined. Information displayed on the client device may be a pop-over, pop-up, toast or modal display as known to those knowledgeable in the art.

If the determination of the programming in block [2120] is not a match and thus the main media content has not previously been analyzed, the programming code as illustrated in FIG. 3 continues to code block [2310]. Here, the system uses a quick analysis method by looking for similar media content that has previously been stored and analyzed. To achieve a timely user response, a basic quick analysis response may be derived by first determining and fetching the previously stored and analyzed similar media content analysis attribute vectors and comparing the likelihood of a similarity match to the media content under current review. Block [2500] uses a similarity engine for comparison between the previously fetched main media content and similar content pointed to by parsing a stored list of similar links. In one embodiment the output from the similarity comparison [2500] determines the “similarity factor” [2360]. The similarity factor may be defined as the acceptance of similarity based on a predetermined threshold of similarity. Assuming that the similarity threshold is met, the process continues to the next programming step shown in block [2340].

Referring again to FIG. 3, if similar content exists within the platform storage, and the similar content has an acceptable level of similarity factor, the programming continues to code block [2340]. Wherein, after the determination of similarity acceptance, the URL address pointers to all similar content as well as the URL reference pointer for the main content are preferably added to a list of media content pointers. This list of pointers may be used for future indexing and retrieval of additional content under review. Future indexing and retrieving for other similar content may be from other application user's, the same user's or internally as further described below. If the programming of block [2360] determines that the similarity threshold has not been met, and the method has not reached the end of the list of other similar content, then the similarity pointer is incremented to point at another possible similar media content [2320] and the operation [2310] shall repeat by incrementing the similarity attribute list pointer and fetching the next set of similarity attributes from the Content Source Table [1220]. This programming process is repeated until it is determined that there are no more similarity links and that the end of the similarity list has been reached as illustrated by block [2370].

Once the content similarity list has been parsed, and index pointers to all similar content that has been previously analyzed and stored, the method continues with the illustration at block [2350]. At this stage of the programming flow the programming quickly parses a list of content provider ratings, preferably known as the “content providers ratings list” and looks for a match of previously rated providers with providers of the current content. In addition, the content provider ratings list is parsed to fetch source provider ratings for other content previously sourced by the same “content source providers”. Content source providers may be defined as the authors, publishers or distribution networks of original or similar media content. For example, the previously stored provider ratings may reference one or more occurrences content source providers that historically have misleading propaganda or high standards of content veracity. Provider propaganda as previously defined, may be further defined in terms of content containing bias, lean, poor-quality, slant while high veracity standards may reference high levels of transparency, content quality, and content provider reliability. The list of content provider ratings is preferably assembled from crawling public or private reviews, third party fact checkers and crowd sourced reviews including other reviews pertaining to the content source providers. If one or more rating sources are found [2350] the process continues [2360] wherein the method extracts third party publisher ratings, repeated occurrences of content bias or on the other hand a history of content reliability and quality from previously stored rating tables [1500]. Thus, the purpose of the quick content rating system is to return to the user an estimation of content and provider veracity in near-real time. When content data and information are similar to the main content, previously analyzed media content may be similar enough to quickly accumulate a response. If in the programming process block [2350] finds one or more matches and the process of extraction and augmentation [2360] is complete, the analysis and rating, performed from similar content and content source provider analysis is further processed [2180] for subsequent storage in the content Analysis and Ratings tables [1500]. Once stored the process continues by display of the similar content analysis results [2200] on a least one client device. Thus, one method of the present embodiment uses similar articles and simple provider ratings to quickly assess the veracity of the content under review if the similar media content has sufficient similarity to the current content under review. if the process of [2350] determines there are no previously analyzed results that are similar enough to the content under current review and no content source provider matches with previous ratings, the programming continues to block [2365]. Code block [2365] notifies the client device user either directly from the mobile application or through a web-browser display, with indication that the media content is under further analysis and to “please stand-by” for display of the completed content analysis and other results from the main media content analysis. The notification is meant to inform the consumer that further time is needed to run a full analysis. Thus, the preferred embodiment uses previously fetched and analyzed similar content and previously fetched and analyzed content source provider ratings, when available, to respond quickly to the user's request for main content analysis.

Once again referencing FIG. 3, the programming continues by using the veracity engine and associated pipeline for the analysis of non-analyzed “newly” received main media content. Block [2410] programming determines the “attribute segments” of the main media content. Attribute segments may be extracted information like the main content topic, the content release or creation date, author, publisher or network syndication sources and the like. The veracity engine pipeline programming uses media “content segmentation” to extract and store segments of the main media content attributes. Content segmentation may be defined as certain content subjects like the main and sub-title topics, content creation or publication dates, original author or content creator, content references, publisher or syndication network name and other keywords and key-phrases as needed for further analysis. The main attribute segments are vectorized for future quick parsing and subsequently stored in one or more storage tables of the system. One such storage may be the Content Analysis and Ratings tables [1500]. In addition, attribute segments are stored and referenced using table indexing and may also contain web-based URL reference pointers allowing further indexing of the URL content source tables [1220].

The programming for the veracity engine pipeline continues with block [2420] used to crawl the web for related content, similar content, and additional content source provider reviews and ratings. The programming of blocks [2410] and [2420] may be used to; 1) identify and fetch information pertaining to the analysis of the new media content under review, and 2) to preprocess and store results for future content quick analysis.

The programming illustration continues in FIG. 3, subroutine block [2610] wherein, the similar content engine, preferably using Artificial Intelligence programming to search for similar content, determines the contents topic(s), keywords, sentence segments, attributes and other important segmented information is stored and subsequently used for search and comparison to find similar content and to build a reference list of similar content referenced by associated URL pointers. Assuming, and for the purpose of illustration, the output from the similarity search engine of block [2610] results in successful web-links that point to one or more pieces of similar content, the associated URL pointers are stored as illustrated in code block [2620]. URL pointers are used address similar content which, once fetched will be rated and ranked by content similarity thresholds. The method of finding similar content continues with program step [2630] to determine if the number of similar content links is sufficient for analysis to provide ranking and reporting results back to one or more client devices. The accumulated link-list of similar articles [2600] is then used to reference similar articles by fetching and storing the actual similar media content referenced by the list of content links previously built by the link-list loop ending at block [2630]. This process loop starting at block [2410] and ending at block 2630 of FIG. 3 preferably is used to build the similar media content attribute vectors as previously described. Thus, in an embodiment the similar media content attribute vectors are created by pre-processing and analyzing fetched similar media content.

Thus, the programming illustrated in [2430] may build one or more similarity vectors for future quick pre-parsing of the list of similar media content used in future similarity searches. A link is added to the index list for each similar content possibility. Furthermore, the programming of block [2340] stores the linked list of pointers and indexing keys and in addition stores the processed attribute vectors and associated content segment attributes output from the similarity engine into the URL and Content Source table [1220].

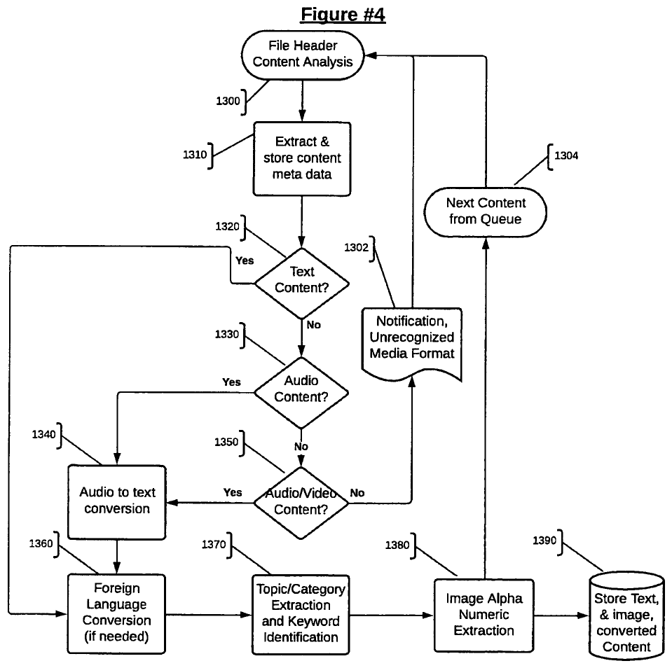

Proceeding one again with FIG. 3 block [2340], once the content segment vectors are built the veracity engine is invoked to run analysis on the main content previously fetched and the similar content referenced by the similar content links stored in the URL and Content Source table [1220]. The veracity engine of FIG. 1, block [240] analyzes both main and similar content using AI and Machine Learning routines as further illustrated in FIG. 4 and FIG. 5 of this specification. After completion of the veracity engine analysis the remaining programming preferably stores the analysis and rating results for all URL referenced content identified into the Content Analysis and Ratings Tables [1500] for subsequent display output [2200] typically displayed on one or more client devices. Thus, the flowchart of FIG. 3 illustrates one method for real-time main media content analysis using previously analyzed similar media content and a method and process for handling the analysis of new and similar media content.

As previously indicated, Main and similar media content URL pointers may be used to fetch content from a plethora of media content sources. Many of the media sources may have different media content formats, some proprietary and some based on industry standards. The preferred embodiment without limitation will reference the media content not by the actual media format but just by the media type. For example, the media format may be MPEG4 for audio/video content type. But there are many formats in addition to MPEG4 for audio/video content type. As known to one in the art there are many different format converters for different content types. For the preferred embodiment of the present invention, only the content type will be used, and the assumption is that for each content type there exists a conversion application or programming tool to change between formats without destroying or altering the original content. For the present invention, and without limitation, Text, Images, Audio, Video and Audio/video make up the typical media types outlined in a preferred embodiment.

FIG. 4 illustrates one of many methods used for conversion between media types to get the media content pre-processed into a format that delivers a common data format, or base format, as required for further processing and analysis. One embodiment of the present invention assumes that all content be of textural format including static 2D images for subsequent processing by the veracity engine Pipeline. In another embodiment, content may be processed by the veracity engine pipeline in the native format that it is received, without pre-processing or conversion. In yet another embodiment, the fetched content maybe processed directly as streaming video, or 3D graphics. For the preferred embodiment, format conversions between different formats may be used to get the content into textural and 2D image formats as known to those knowledgeable in the art. FIG. 4 illustrates the process of interpretation of different media types and the conversion process to standard textual and 2D image formats.

The Illustration of FIG. 4 shows one preferred method used to convert media content to a standard format containing just text and static images. Conversion of media type may be required as a pre-processing step for the subsequent analysis process carried out by the veracity engine pipeline programming. Block 1300 illustrates the start of a process used for general topic segmentation as needed for the programming to complete segment extraction and analysis. Staring with block [1300] certain meta data may be extracted from any of the media types to be converted to meta data and stored as content attribute segments. These meta data segments may include transport information, URL addresses, media format and other data that accompanies the media content. Accompanied information extracted from media content header files is typically formatted as readable transparent text information. In one embodiment, the meta data contained in the file header information may need decompression or decryption by one or more authorization keys. The meta data are analyzed and stored by content ID along with any indexing or reference as needed and depicted in code block [1310]. Meta data segment IDs are typically used to reference data extracted from the media content transport envelope or embedded as plain text in one or more text formats. Once the meta data is extracted the method stores a separate segment ID attached to the media content for future referencing and ease of use. The initial test on the content determines if the media type of the content is simple text that can be easily extracted and stored [1320]. If the content is of standard textual format the programming skips additional pre-processing and adjusts the textural format by format conversion to one or more textural format standards for further processing. Once the preprocessing of the textual content is complete the process continues with code block [1360]. In one embodiment the textural information may also contain one or more images typically in one or more imaging data formats as known to those knowledgeable in the art. Images are also preprocessed if needed to get all images into a standard format for further processing by the veracity engine pipeline.

Referring again to FIG. 4, Assuming the programming of block 1320 determines that the media content is not of text or image type the process continues with programming block [1330] where a check for Audio media content is sourced either in downloaded or streaming formats. In one embodiment, Audio and Video may be combined within a single stream. If audio exists in the media download or stream a conversion method is used to interpret the audio content portion into text with Audio to Text conversion tools. If the audio is not natural language where speech recognition may be used to convert spoken language to text, alternative methods may be used to determine more about what type of audio the media content contains. If the audio content is present in the media, code block 1340 converts the natural language “speech” into textural format [1340] for subsequent storage and analysis. In the preferred embodiment, the method supports one or more foreign language conversions [1360] as needed for further analysis by the veracity engine pipeline programming. In another embodiment, if the process of block [1330] determines the media content is of Audio/Video combination the present invention proceeds with block [1340] for extraction and conversion of the audio into text and subsequently assigns the reference audio segments into timeline pointers matching and synchronizing the audio text to one or more frames of video within the media content. If the programming of block [1350] cannot determine either the media type or media format from the meta data header information, the information cannot be processed. In this case a notification message [1302] “no data to extract” is sent to the client device for user notification and the process continues to the next segment, of content [1304] in the fetch content media queue for processing.

Once again referring to FIG. 4, programming block [1360] illustrates the media content type has been identified and converted as needed for processing. In one embodiment, the textural components of the media content may be simply a translation to one or more foreign languages and is further translated by the program instructions of FIG. 4, block [1360]. The textural media content may now be in a format wherein various topics, keywords and keyword phrases may be extracted into one or more category-based list of attribute segments as illustrated by code block [1370]. Keywords, key-phrases, and other attributes are cataloged by attribute segment indexers and subsequently used for future reference. In an embodiment, static 2D or 3D images with embedded textural media content [1380] may be present in the media stream or be part of the original media content and must be treated separately from normal Text/Audio/Video media types as previously mentioned. In another embodiment, audio/video streams may be decomposed and reformatted into textual audio time-stamps used to index into specific video segments wherein the audio/video segments can be further analyzed and played back upon user request on the client device. Thus, after at least one media segment has been fully converted, pre-processed into segments and keywords and key-phrases have been extracted to a common standard media format, the method stores the converted output to local or remote system storage [1390] for further processing by the veracity engine Pipeline.

The veracity engine apparatus and programming of the I-Hub veracity exchange platform and the apparatus of the present invention is further illustrated in FIG. 5. The veracity engine programming method of the present invention is illustrated in FIG. 5. Multiple program code sub-blocks are shown in FIG. 5 that make up the preferred programming flow, also called “the veracity engine pipeline” of the of the present invention. Each sub-block in FIG. 5 represents one or more groups of programming instructions that in its entirety enables the veracity engine pipeline. Thus, the veracity engine pipeline programming illustrated in FIG. 5 provides one method to accomplish the main media analysis for the present invention.

Referring to FIG. 5, programming subroutine code block [140] begins the Machine Learning (ML) process of main media content analysis. Block [140] preferably, extracts content topics into topic keywords and topic key sentences from the pre-processed media content previously fetched or stored as illustrated in FIG. 3 herein. Topic keyword extraction tools of the preferred embodiment are based on machine learning and artificial intelligence algorithms as known to those knowledgeable in the art. Code block [140] automatically “reads” the pre-processed media content and extracts one or more main topic segments and aggregates the result into the most relevant topic statement or content summary. Topic segmentation extraction is in addition to keyword and key-phrase segment extraction as previously described. The main topic extraction is a process known as content classification wherein code block [140] performs topic extraction to classify the media content text documents into a plethora of predefined categories. Furthermore, labels are created to customize the ML models for unique use cases using trained data from other previously analyzed media content.

The preferred process continues with FIG. 5 code sub-block [340] which in one embodiment determines the veracity of the content source provider. This method requires that the content source provider has previously published, provided and/or syndicated one or more publications in the past and such content has been previously analyzed by the veracity engine [240] pipeline. Preferably, and not by limitation, one method to determine the veracity source rating of content providers is by crowd sourced provider ratings and comments. Another is by source provider review sites that analyze a multitude of media content from a single source that classifies the results in quality scoring, veracity, bias or lean and history by listing the number of occurrences of media content positioning or by other means. The program code of sub-block [340] may include looking at all identifiable references from all identifiable content source providers including provider history to aggregate the final list of insights and expose any flags or anomalies relating to the media content under analysis.

As previously illustrated in FIG. 3, a list of similar content pointers is used to fetch similar media content for analysis [145] is also shown in FIG. 5. Similar content analysis is used to compare media attributes segments within the main media content along with similar media content attributes to determine similarity proximity matches. This is accomplished by filtering for minimum desirable error of similarities between these different media content components. When similar content attributes are identified, link lists used for indexing specific attributes of the similar content are stored. Similar content attribute links are then used to further assemble the similarity conclusions of the current media content analysis.

Continuing with FIG. 5 code block [150] the method aggregates attribute segments from all similarity attributes pointed to by the previously built attribute list and attribute segments sourced from the current content under analysis. The Aggregated data is built into search topics that are used to compare and find similarities topics from third-party fact checker databases. The third-party fact checkers are supported by a plethora of fact checkers (humans) that manually research and report commonly reported content statements as fact, fiction or partially true. Programming illustrated in block [150] continues by scrubbing of the aggregated media content for additional information to call out content statements enabling consumers to gain insights as likely to be true or false, partially true, partially false or non-conclusive.

Again, referring to FIG. 5, and illustrated by programming block [152] Machine Learning (ML) algorithms are trained to identify, extract and subsequently classify “Entity”, “Sentiment” and “Entity Sentiment” related content segments from previously processed media types. Entities are defined as the foreground of the content and are considered key factual details mentioned in the content. On the other hand, Sentiment, or Sentiment Analysis is the process of categorizing opinions expressed in media content. Sentiment Analysis is typically used to determine the authors attitude towards a particular topic, product, and the like. Whereas, Entity Sentiment Analysis combines both entity analysis and sentiment analysis and attempts to determine the sentiment (positive or negative) expressed about entities within the content. Entity sentiment analysis is typically represented by numerical score and magnitude values and is determined for each mention of an entity. Those scores are then aggregated into an overall sentiment score and magnitude for an entity within the media content. The use of ML for entity and sentiment analysis is commonly known to those knowledgeable in the art. For a preferred embodiment, the method and process of how machine learning is applied to achieve results according to the methods of the present invention are disclosed. In one embodiment an API may be used to interface to at least one entity extraction and analysis programming function. APIs may be used to automate or assist the members during uploading, setting content attributes or other processes that normally would be manually performed by one or more members. Prior to entity and sentiment analysis the method may perform syntax analysis by use of extracting specific content components from the current content under analysis. Syntax analysis is defined as the process of token phrases and sentence extraction used to identify certain sentence structures and create dependency parse trees for each extracted sentence. Once the content under analysis has undergone syntax extraction and parsing the process of entity extraction and analysis can begin. The purpose of entity extraction is to identify certain entities within media content and label them by types. By example and without limitation, types of entities may be defined as a date, a person, a group, contact information, organization, location, events, products, and the like. In addition, based on what content type is undergoing entity extraction, custom entity analysis may be used to identify entities within the content that contain domain-specific tokens or phrases. Continuing with FIG. 5 block [152], the programming also process content sentiment, again by analysis on the extracted sentences, to understand the overall opinion, feeling or attitude expressed in the extracted text segment. In one embodiment, sentiment analysis may be tuned to one or more domain-specific extracted sentences resulting in customized sentiment ratings or scores. The sentiment analysis may determine how an author, publisher, influencer, or network of media content feels about one or more subjects or certain components of the subject.

Once entities, sentiment and entity sentiment are extracted and analyzed, the programming illustrated in FIG. 5 block [155] uses content indexes to compare the extracted sentences to one or more of many biases/leans and/or opinionized predefined categories. The content classification process may also create custom labels used to customize models for unique use cases based on previously analyzed data. According to the method of the present invention, extraction and analysis results are subsequently used as additional training data to build the models for sentiment and emotional context classification using machine learning and model training optimizations. When the programming results complete, the analysis results of block [155] are used to build a series of summary statements [157] pertaining to how the media content is positioned. Biases, leans, hidden agendas, and misinformation also termed “propaganda”. Content propaganda within the media content is identified, classified, and flagged in a positioning summary notification to the application user displayed on the client device. Analysis output is displayed to one or more consumers on at least one client device. It consists of content anomalies in the form of media content notifications or flags. Each notification or flag contains an individual URL or reference that may be in the form of highlighted text, pop-up window or modal and typically contains at least one hyperlink to the media content source location. The notification or flag reference is provided to the consumer for additional details or discovery.

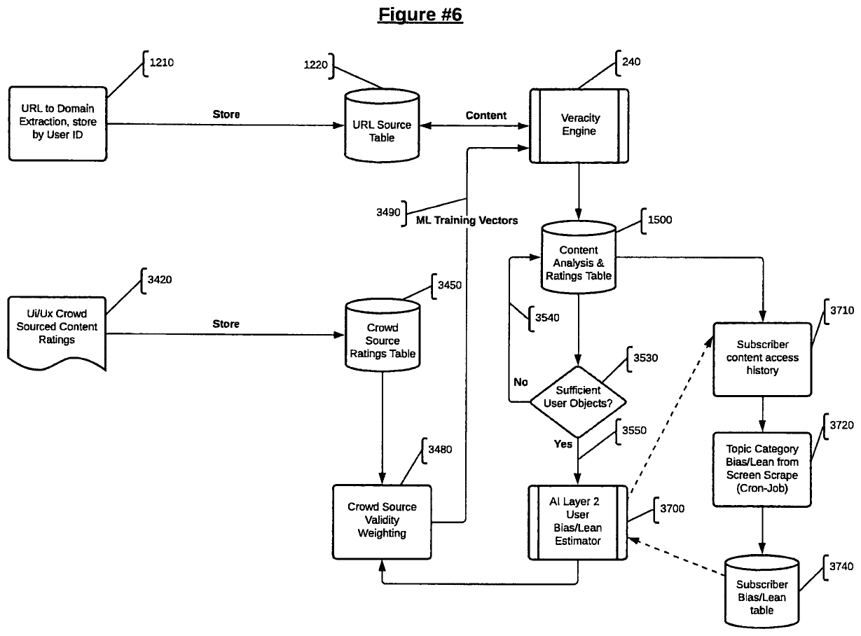

Next, the method continues as illustrated in FIG. 5 programming blocks [3400 and 300]. The preferred method combines bias and lean analysis with crowd sourced ratings and reviews from both the recent content under analysis and the identified similar content (previously illustrated in FIG. 3). The process of determining propaganda, typically bias and lean in crowd sourced analysis, are further illustrated in detail in FIG. 6 herein. Crowd sourced analysis may also be called “reviewers” analysis and may also be media content reviews generated from qualified i-Trust subscribers. By example, and not limitation, the resulting outputs from the detailed coding blocks of FIG. 6 may come from qualified subscribers that are identified as not having previous been identified as having strong bias or lean and/or those subscribers that who do not have a history of prior authorships or publications that has been identified as having strong bias and opinions aligning to one side or another. By example, in politics, individual subscribers in one or more crowd sourced reviews may be identified as having very strong bias to either the far left or far right on political issues.

Referring again to the veracity engine pipeline of FIG. 5, the programming illustration of block [170] uses all the previous analysis results, along with the crowd sourced results to form the output analysis of the current media content under examination. It is important to understand that one preferred embodiment identifies certain “content flags” wherein information has been validated, flagged or is suspect of validation, allowing the user to determine their own conclusions from the listed information of the analysis. In addition to content flags, certain fact checking sources are identified and listed for the main and related topics to help the user understand what facts have been checked by fact-checking outlets and third parties. Further-more, the ratings and reviews pertaining to the main-topic are generated directly from all available crowd sourced information along with output showing any perceived subscriber bias, lean or opinions typically because of their own content analysis and reviews. Another method used for media content analysis is illustrated in programming block [175] where, the analyzed content has assigned to it a date and time of publication indexed by content topic title. The time-line graphing gives relevancy or non-relevancy to derivative works and publications that are related to the main topic under analysis. The time-line analysis as illustrated [175] includes a similarity/non-similarity index relating to the original “first” or “earliest” similar content time-line identified. Thus, the present method of the invention allows users to see when similar content was introduced or published, a similarity score indicating a ranking of similarities to other articles, key-words and sentence structural differences including missing or added information. In one embodiment, for example, the identification of restructured sentences that may have changed or altered the original meaning by integration of “added” or “left-out” content segments as related to previously published similar content.

Another method of Veracity Analysis is further illustrated in FIG. 5 block [180]. Here the present invention uses one or more smart contracts to determine if the content has a legitimate distribution or ownership license. This method ensures that the content has one or more smart contracts allowing transparency in ownership and distribution rights and for tracking of original licensed content enabling higher media content veracity. The method of one embodiment uses licensed content look-up to determine if the original content can bear the seal of properly licensed or owned content helping the consumer to identify content that may be licensed vs. non-licensed. In an embodiment the tracking of licensed content may provide time-line of similar information helping consumers to identify content derivatives and changes from the original content. By identification of properly licensed or properly owned content between the content suppliers and the publication outlet (demand partners), the present invention helps consumers determine more about the legitimacy of the content. Furthermore, properly owned, or licensed media content with a recorded time-line of transactions and legitimacy improves the overall quality score reported to the veracity exchange members. The present method of using a “veracity-seal” to brand or quantify quality helps the content consumer gain trust about one piece of content over another. For the veracity engine analysis, smart contract licensing lookup of the original licensee's and licensors and any follow-on licensees, owners, publishers, and syndication networks (herein “the providers”) may also be used as supplemental information to augment the results of the veracity engines media content analysis.

Lastly, again referring to FIG. 5 of the present specification, all the information described in previous programming blocks pertaining to the veracity engine pipeline are combined into “content segment vectors” [185] that may be subsequently used for quick content decoding of previously analyzed media content and client device delivery as display information on a client device. Quick output display information, when recognized as either main or similar content analysis output to one or more client devices enables quick insights to media content prior to during or after consumer media content consumption. In addition, the content segment vectors may be used for additional ML training within the system and method of the present invention. Thus, the present invention uses the brand name “I-trust” to represent the application and application platform that runs the programming defined herein. Thus, according to the present preferred embodiment, the content segment vectors are preferably stored in one or more databases [1500] that may be local to the back-end platforms or remotely distributed or directly within one or more client devices.

Referring to FIG. 6, an illustration of one possible embodiment used to identify and extract crowd source rating bias from one or more individuals or group reviewers is shown. Reviewers review content or insights that are input, processed, analyzed, and summarized for output display from the I-trust platform. One embodiment of the present invention uses crowd sourced reviews and ratings to determine media content ratings and rankings for content veracity that may include displayed flags and notifications. The software programming illustrated in FIG. 6 inputs crowd sourced ratings previously stored in the Crowd Source Ratings Table [3450]. These ratings are indexed by the URL Source Table [1220] that also hold the “extracted domain names” derived from the URL pointers and used point to the media content. The stored media content is further used as input variable and covariate data for the veracity engine pipeline [240]. The crowd source ratings table [3450] includes “True/False” Positioning results that are also referenced by the user index table. Extracted domain names and user identifiers are stored and used to determine if one or more reviewers within the crowd of reviewers has one or more strong or heavily biased pre-dispositions about the topics contained within the media content. The determination of strong bias or opinions is based on at least one or more previous similar topics reviewed by the reviewer. The pre-determination of reviewer bias is important because individuals with strong opinions that lean too far outside the standard deviation may not be able to fairly judge, rate, and review the subject matter without adding bias, misleading information, or strong opinions. Thus, FIG. 6 of the present embodiment illustrates a novel dual AI method to determine a “reviewer validity rating” for each of the individuals or groups performing crowd-sourced reviews. Reviewers with a history of strong bias, lean or prior positioning are filtered out by a weighting process prior to running the veracity engine ML models. In one embodiment, the ML models that “review the reviewers” are trained to recognize strong emotional responses, strong opinion, and strongly biased positioning by individual reviewers. By employing weighting coefficients to the independent input variables that feed the crowd source portion of the veracity engine models, inherent crowd source bias, lean and positioning are nullified, or at least minimized, and the veracity engine ML models will converge on a fairer more trusted analysis.

Referring again to FIG. 6, storage and programming blocks [1210], [1220] and [240] herein illustrate the building of one or more source tables consisting of URL's that point to main and similar media content and, where the content resides in one or more web-sites, social media or content syndication network sites and the like. Also, as described previously, content analyzed by the veracity engine [240] of the present invention uses certain information in the form of ML training vectors [3490] derived from the crowd sourced weighted ratings and reviews [3480] to determine certain aspects pertaining to the veracity of one or more of the crowed sourced reviewers. Furthermore, the Crowd Source ratings are used to train the veracity engine models and may be used as dependent variables to influence content rating decision weighting parameters.

Furthermore, FIG. 6 code block [3530] illustrates one method to first determine if everyone within the crowd sourced subscriber base has had sufficient similar articles read within some time-frame to qualify as a valid, non-radical reviewer of the content under analysis. Secondly, if available, the preferred method uses a secondary ML trained model [3700] to estimate and report certain bias or lean based on the reviewer's recent history of content previously fetched by the platform or through cookies, browser history or by other means. Code block [3700] is further detailed and illustrated in FIG. 6 sub-blocks [3710, 3720, 3740] that together are illustrated by programming block [3700]. Initially, programming determines the subscribers content access history [3710] to build an index of recently accessed media content and runs similarity algorithms to filter and determine which content from the index is like the content under review. Second, the filtered content history index is again used [3720] to parse a known list of web-site domain names and within those domains, web topic categories that have previously been ranked and rated for content quality, bias/lean and certain media positioning by other independent publications. Independent publications may include news-letters, web-sites that specialize in reviewing content sites, media outlets, and other sites that specialize in content ratings and reviews. The output from the bias/lean estimation model is stored in the Subscriber Bias/Lean Table [3740]. Entries within the Subscriber Bias/Lean Table are stored by user ID index and are further used by the AI layer 2 user bias/lean estimator model [3700] for subsequent subscriber positioning information lookup. Thus, as illustrated in FIG. 6, the validity of the sourced information from the crowd can also be analyzed for pre-determined bias/lean coming from the subscriber base doing one or more crowd sourced ratings and reviews. Significant reviewer bias/lean outside the standard deviation may be tossed out or weighted appropriately to find the “near center” crowd sourced reviewers for more normally biased ratings and reviews.

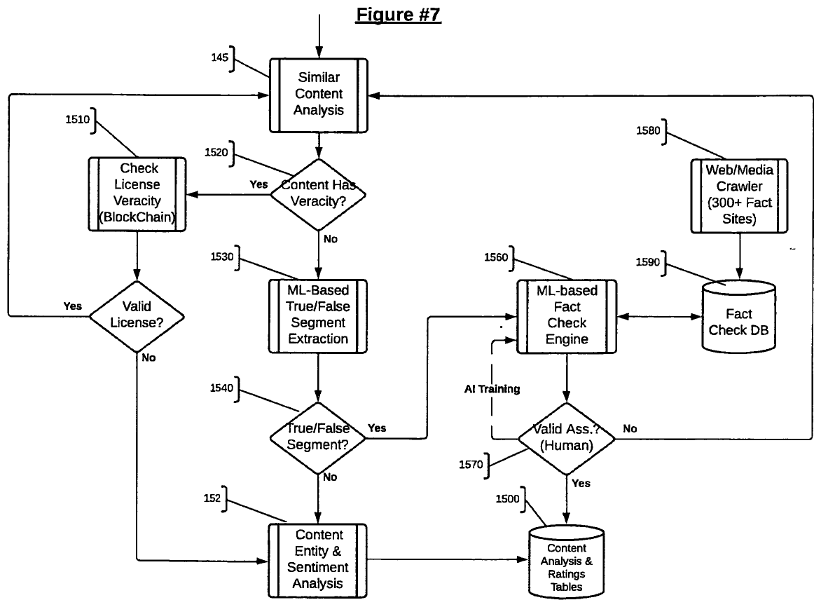

FIG. 7 illustrates the programming code and resulting method of determining key phrase true/false fact scoring and validity of aggregated extracted key phrase segments. The aggregated media scrubbing of FIG. 7 is based on public and/or private fact-checking services currently from over 300 different worldwide sources. The fact-checking responses from the third-party fact-checkers are used to gather additional analysis data used to augment the trained AI models such that the models have additional insights from one or more fact-check networks. One preferred embodiment uses the method illustrated in FIG. 6 to determine the veracity of the actual reviewers that do the fact-checking. Code blocks [145] and [152] of FIG. 7 have previously been outlined and are part of the preferred embodiment of the veracity engine illustrated in FIG. 5. Code blocks [145] and [152] are included in FIG. 7 for presentation purposes and without limitation, used in the present method to aggregate third party media scrubbing.

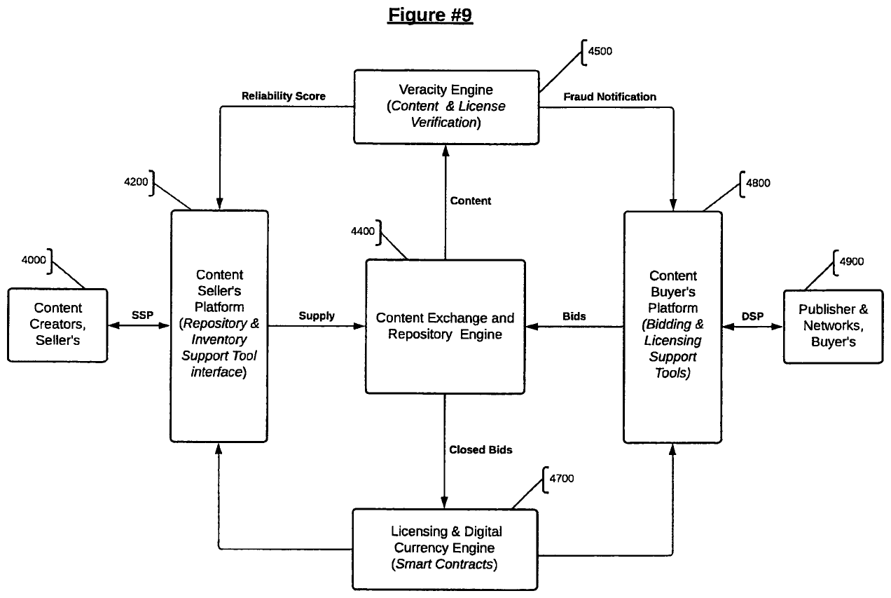

The programming method of FIG. 7 starts by determining if the media content under review [1520] has previously been analyzed by the present invention and thus, is complete with previously analyzed content veracity and subsequently has existing data in the one or more locations of the Content Analysis and Ratings Table [1500]. If the media under review has previously been analyzed, the programming block [1520] has no need for additional scrubbing and the process continues to code block [1510]. The programming of [1510] performs a check to determine if the present media content has a valid license and is under one form of ownership or licensing contract between content creator, content owner or their representatives, wherein, the process of the I-HUB exchange is further described in detail and illustrated in FIG. 9 herein. When a valid license does exist for previously analyzed content, there is no further analysis or scrubbing needed and the process continues to the next similar content that may require media scrubbing [145]. In an embodiment, the same programming method as illustrated in FIG. 7 may be used to check the main content as well as similar content. In one embodiment, when the code of block [1520] has determined the content has previously been analyzed the analysis date (preferably stored in the Content Analysis and Ratings Table [1500]) may be determined to be too old to accurately use the third-party aggregated scrubbing data from one or more third-party fact-checker outlets and the process of block [1520] may continue to code block [1530].

Continuing with FIG. 7, in the programming illustrated by block [1530], the media content under review undergoes the process of true/false segment extraction. The machine learned model of the present invention determines how to identify which portions of the media content under review have statements that call out a one or more situations where the content indicates a key phrase or conclusion segment that could be true or false. This determination results from the analysis of one or more trained models wherein, the training vectors are generated from measured content resulting from the third-party fact checking services and/or error analysis as known to one knowledgeable in the art. If no True/False assumptions are found that need fact checking, the process continues to other programming such as the previously defined Content Entity and Sentiment Analysis programming [152]. When statements within the content under review have identified key phrases or keyword segments that need third-party fact checking verification the process continues from code block [1540] to code block [1560] for automated fact-check based on the previously trained ML fact-check model. In one embodiment, the results from the fact-check ML model may be supplemented with human fact checker validation [1570] prior to results storage in the Content Analysis and Ratings Tables [1500]. The human analysis subsequently checks that the results of the ML-based Fact Check Engine [1560] are accurate and properly identified for the media content under review. If not, adjustments and corrections are made to correct false paths generated by the ML-based fact checker [1560] and the corrected analysis is input back as AI training vectors to re-build the ML fact-check model for additional fact-check ability and accuracy. In one embodiment the process steps of validating the results of the ML based fact checker [1570] may be performed by one or more of the Web/Media fact checking sites [1580].

Again, referring to FIG. 7, the programming code of [1580] continually scans the plethora of fact checking sites and newsletters using a time-line graphing approach for scanning media content and reviews of specific topics. The time-line may be used as an index to the media content context of certain assumptions made by both the content authors, publication sites and the fact-checkers. The results of at least one fact-checking review for each published media content is stored in the Fact Check tables [1590] referenced by entity entries of keyword indexes. The entity entries are used to look-up the True/False reviews by the plethora of content fact-checking sites [1580]. The method of the present invention supplies the ML-Based Fact Checking Engine [1560] with third-party true/false ratings sourced by the Fact-Check tables [1590]. Once the Fact check engine results have been verified [1570] the resulting determination for accuracy and veracity rating are once again stored in the Content Analysis and Ratings database [1500] for subsequent analysis and integration into the final output response sent back for display on at least one client device. Entity scrubbing for factual data verification especially by fact checkers may not be fully accurate so the present system will only flag items in the media content that do not align. The flagged items will only report and notify consumers about the differences. It's up the media consumer to understand and uncover the truth based on discrepancies pointed out by the present system and method of the invention.

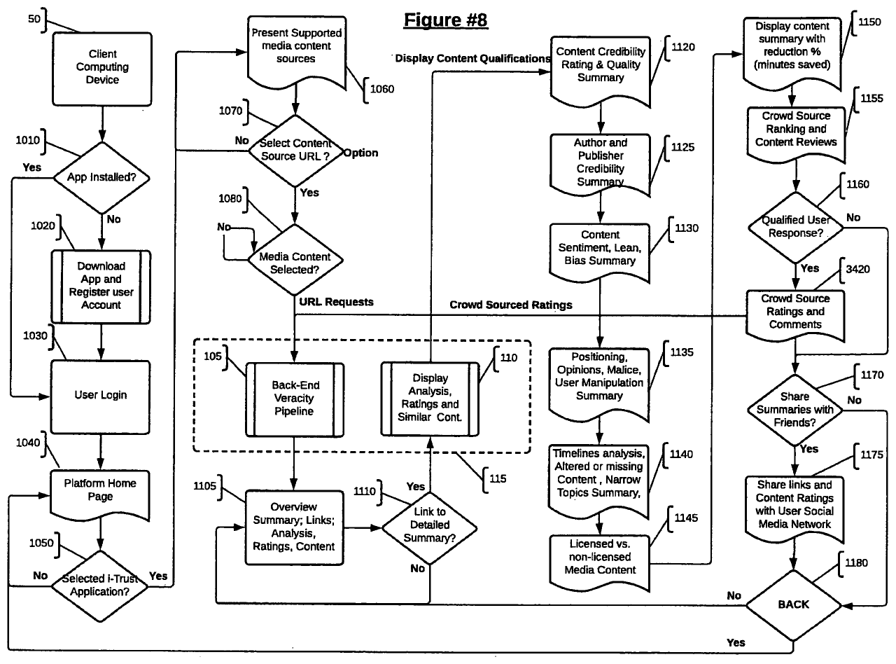

The method of the present invention automates the process to help the media consumer with “Truth” discovery by displaying veracity indicators on a four-quadrant graph with hyperlinks (link-dots), that when selected, display the highlighted media segments from the original source media. The method classifies and displays the output analysis in one of four graphical quadrants or by other similar means. Link-dots that end up in the upper right quadrant indicate the main media content has Veracity and has been written or published by factual independent (non-influenced) sources. Link-dots that end up in the lower right quadrant indicate the main media content comes from highly influenced but factual authors or publishers. Highly influenced authors or publishers is defined as authors or publishers that have been paid by sponsors or other special interest groups, or those that work for others that manage media content with bias or lean. Link-dots that end up in the upper left quadrant indicate authors or publishers that have high independence (no-influence from others), but media content tends to be fictional not factual. Link-dots that end up in the lower left quadrant indicate the highest likelihood of propaganda typically containing low accuracy and low author or publisher independence. The lower left quadrant typically indicates media content that is both highly influenced (paid propaganda) and fictional not factual. In addition, each of the quadrants that contain Link-dots is represented by a different color for “at-a-glance” main media content review. The I-trust platform client device user interface and execution method used to help consumers gain trust in media content is illustrated in FIG. 8. FIG. 8 illustrates one embodiment of the User Interface/User Experience (Ui/Ux) programming and a step-by-step process that enables users to interface with the I-Trust discovery platform. The preferred embodiment contains a Client Computing Device [50], the I-Trust application software, preferably installed on the client computing device, and one or more client device supporting application frameworks. Wherein, and without limitation, the one or more installed application follows a programming process like that illustrated in FIG. 8 blocks [1010, 1020, 1030, 1040, 1050] and of the present invention as described below and as known to those of the art. The process includes determination of the correctly installed I-trust client application [1010] and if not, user notification where to find, download, login and follow the preferred registration process. Once the I-Trust client device application has been installed and the user has registered, given user credentials, and granted application access, the user logs into the client present application to begin the process of using the I-Trust application and associated client device that includes the use of the backend platform software.

Referring again to FIG. 8 the user flow and process continues with a display and control of the application home page [1040] on the client device. The application home page contains the operational settings, profile information requests and application controls that may be set-up by the user. The client device operates with the ability for the user to browse the internet and gain access to information located on a plethora of Domains containing website software, information, and various media content. In one embodiment the present invention supports use of mobile device application frameworks like “Web-View”, in yet another embodiment the present invention may be written with at least one alternate mobile application framework or, may be written totally without third party frameworks. In alternate embodiments the I-Trust application software may be downloaded and installed on desktop or dedicated compute systems. In the preferred method the mobile framework supports the means to intercept browser requests from the user that may point to media content from one or more networks. The media content may then be selected for content trust and veracity analysis by the veracity engine pipeline of the present invention. The next step in the process of FIG. 8 opens the I-Trust application [1050] and selects one of a plethora of supported media content sources [1060] or provided topic domains. The mobile device user may begin by searching for and browsing to a topic of interest on the Internet or catch-up on the latest social information, view the latest news sources or look for media content sources open for consumption. In another embodiment, the system may use RSS feeds in lieu of one or more supported media content sources. Based on the user selection at least one URL is selected [1070] that presents a URL pointer to the main media content of interest to be consumed and subsequently analyzed by the I-Trust application software platform. Once the user selects one or more media content selections [1080] the process continues with the backend software [105] picking up the URL content pointer via the network interface [115], reading the media content under review and referencing similar content, as previously described herein. This analysis process performed by the veracity engine pipeline is mostly transparent to the user until the next step in the process is performed. Once the main content has finished loading, the analysis process begins, and the output results are sent via the network [115] back to the client device [50] and summary results are presented to the user [1105] via the client device output display. In one embodiment the output from the client device may be in the form of an audio output such as natural language synthesis to reproduce human speech. In another embodiment the speech may be adjusted to the language of choice for Localization as known to those knowledgeable in the art. In yet another embodiment the output may be in audio/video or picture formats as supported by the client device system. Programming block [1110] is designed to enable the user to tap, use a mouse click or speak to input a user's request on the client device for at least one detailed veracity summary of the media content. In the preferred embodiment this method is used to ask for more detailed analysis of the presented analysis summary as outlined in programming blocks [1105,1110], again illustrated in FIG. 8.

The process of displaying detailed content qualifications is further represented in FIG. 8 by program code block [110] used to Display Analysis Ratings and Similar Content. Wherein, block [110] is further defined and illustrated in FIG. 8 by the process of programming blocks 1120 through 1180. These blocks are used to display more information based on additional analysis details from the outputs of the veracity engine pipeline analysis. Once again, the user will see the content credibility rating and content summary output [1120] as a general summary or at-a-glance with device client graphical display applications and framework tools. The displayed output may contain hyperlinks to related media and events to help the media consumer justify or abandon trust in the main media content quickly. In addition, the user will see a credibility review summary [1125] for the Author, Publisher, Syndication Source, or other content source providers. The process continues with more detailed information as illustrated in code block [1130] which details the media content sentiment, lean and/or bias summary by highlighting, flagging, and providing insights for certain content segments within the media content. In one embodiment, summary of any of the output analysis results may contain user links that show specific examples of where the media content may contain one or more of the key phrases used for analysis by the veracity engine pipeline. Further, the output display continues to exemplify by pointing to any assumed positioning, opinions, content malice or possible author/publisher manipulation segments [1135] as determined by the analysis of the veracity engine pipeline. In one embodiment, as illustrated by code block [1140] the system and method may output to the client device a time-line display indicating the same or very similar derivative content, including at least the origin and publication date of such pertaining to the same or very similar media content. In an embodiment, the time-line may contain links that further allow the user to open additional summaries of the data sources. Additional summaries may include details outlining at least one of altered or missing content segments, narrowed down content topics or additional information included from previous publications of the very similar content. In an alternate embodiment the percent similarity between like content represented on the time-line may be presented in one or more display formats as known to those knowledgeable in the art.

Again, referring to FIG. 8, code block [1145] determines if the content or any identified very similar content has been licensed for publication through one or more registered media content networks or storage repositories. Licensed media content with proven ownership and redistribution rights helps the consumer determine the quality of the source allowing the consumer of the media content to understand if the original content or similar content is original or an unlicensed knockoff derivative. By choosing and consuming content that has been legally licensed and registered for publication and/or syndication the consumer can associate additional trust that the media content is not an altered derivative of the original. The preferred method to license and register media content is outlined further herein.

Furthermore, the Ui/Ux method illustrated in FIG. 8 continues with additional veracity qualification also output as display information on the client device. The programming illustrated in block [1150] enables the methods ability to display content topic summaries that may include at least one short synopsis of the media content. The short synopsis or content overviews allows users to determine, once again at-a-glance, if the content title matches the actual context of the content story as outlined in one or more title statements. The topic summary quickly allows the consumer to gain insights about the integrity of the media source prior to consuming the entire media content. For example, content may use a topic title to lure consumers to take the time to consume the content but often find that the topic title was nothing but a bait and switch method to get the consumers attention and has nothing to do with the actual content. Thus, the quick view and synopsis of the output summary may enable the content consumer to decide if the content is worthy of the time spent to consume the entire body of content. Within the present specification, “Content Consumer” is defined as; one or more end-users that read, view, listen, sign-in, review or provide comments on one or more application platforms. In an embodiment the short synopsis may include one form of output that indicates a percentage reduction or reduction of word count which may subsequently indicate the amount of time saved by consuming only the I-trust resulting overviews and not the entirety of the media content.

As described previously, the method includes a means of use of legitimate crowd sourced reviews, ratings, and rankings [1155] that may include content, author and channel distribution reviews. As illustrated in FIG. 8 programming block [1160], the determination of what are “legitimate reviews” that may alter the programming path of the present method are further defined. For example, qualified user responses [3420] from crowd sourced reviews are parsed and used as training vectors and independent variables within the veracity engine pipeline [115]. For at least one qualified crowd source review, the model may be retrained to learn from included Crowd Sourced Ratings and thus, weighting the output based on information from the qualified crowd source is used to further enhance the accuracy of the system. In an embodiment, an additional method such as “Contributor Rewards” may be implemented to qualify and reward consumer contributions like; Consumer contributions may be defined as and include user responses; ratings and reviews [1160]. As such, rewards are determined based on the quality of content posted and the amount of customer engagement the content receives. Contributor Rewards may also be displayed to content consumers in one of many methods. One rewards method as known to those knowledgeable in the art may be some number of stars rating the user responses and another may be elevating users to different levels of qualification expertise.

In addition to including qualified crowd sourced information, FIG. 8 shows the programming that enables content consumers to also share particular insights results from the veracity engine analysis. In an embodiment, results and summaries with friends and associates may be shared through one or more third party application interfaces [1170] also known to those knowledgeable in the art. The programming process of FIG. 8 block [1175] enables users to share links that point to the media content summaries with one or more Social Media Networks such as Facebook, LinkedIn, Google Groups, and the like. In an embodiment, the content consumers may also copy and paste content summaries into other user correspondence such as emails or texts. In yet another embodiment, the shared-links used to navigate to the platform summary output may also be used to display details of the summaries and recruit new users to the platform. Lastly, the programming illustrated in FIG. 8 showing one embodiment of the user Ui/Ux flow may enable users to navigate back to previous screens, select additional output such as similar articles or exit the application as indicated in block [1180].

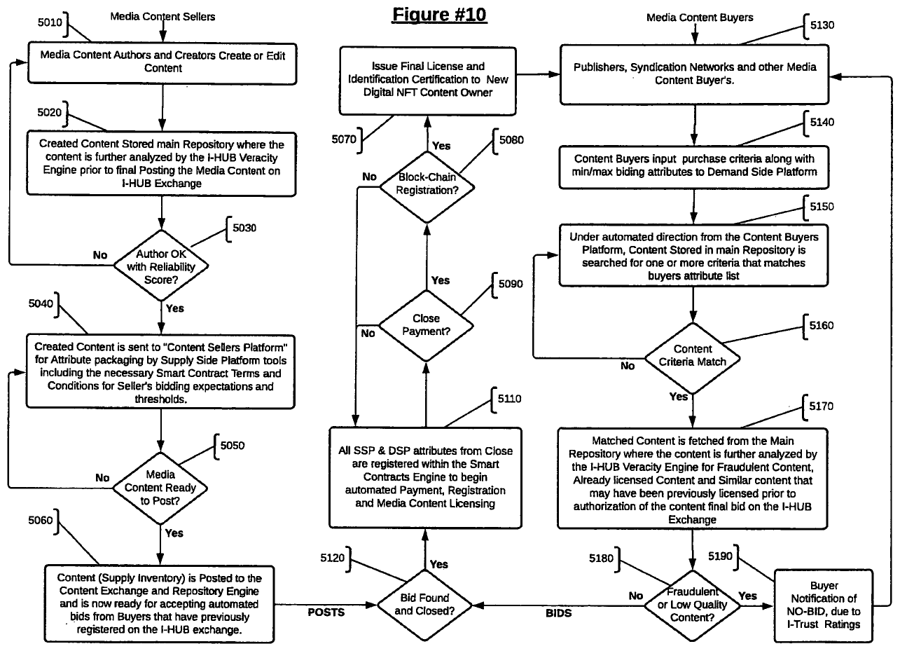

Referring to FIG. 9, a block diagram illustrates the method of the I-HUB veracity exchange platform, also called the “veracity exchange” platform, “I-HUB exchange”, “I-HUB content exchange” or just “exchange” herein. The method of FIG. 9 further illustrates the major programming blocks used for operation of the veracity exchange platform. As illustrated in FIG. 10, each of the major programing blocks shown in FIG. 9 have multiple sub-programming blocks used to enable the method of the preferred embodiment. The purpose of illustration shown in FIG. 9 is to teach a novel method of media licensing using the I-HUB platform. The veracity engine, as previously described herein, is embedded into the I-HUB exchange allowing veracity exchange members to research content veracity prior to definitive agreements for purchasing or publishing of the content. The content veracity exchange method is based on a smart contract engine to automate the members exchange process. The method of the present invention teaches a system and method to test market media content, prior to purchase or publication, typically between sellers and buyers. The subscriber members of the exchange, also called “content providers” or just “providers” that use the method include media content authors, creators, publishers, content syndication networks, social networks, media distribution channels or anyone or entity that uses the veracity exchange platform. Thus, the present invention introduces a method and process for managing and enabling a plurality of media content transactions of qualified, quality media content.

As illustrated in FIG. 9, the preferred embodiment of the I-HUB veracity exchange platform may contain two interfaces used for media Content input [4000] and media content output [4900] from the platform. The content creator's or seller's interface, illustrated in block [4000] and the publishers & network buyer's interface [4900] also send reports and analysis display data as output back to sellers and buyers alike. In addition, veracity exchange members, both buyers and sellers on the exchange, interface to the exchange through customized API's that are running on a plurality of client devices. For the preferred method, the term “qualified-media” represents media content that has undergone veracity analysis [4500] as represented first in provisional patent and subsequently in a currently filed utility patent entitled METHOD AND PROCESS FOR CHECKING MEDIA CONTENT VERACITY whose inventor is Thomas A. Dye. The referenced invention shows the preferred method and process used to identify propaganda in media content, qualify trusted content, and disqualify miss-information or non-trusted media content. Content created or authored by “seller”, “supplier” or, I-HUB subscriber, who are members of the veracity exchange, input media content through the Content Sellers Platform interface [4200]. Content creators, also called media content suppliers, content suppliers or just “suppliers”, are also known as “Supply Side Providers” (SSPs). Supply side providers may operate one or more Supply Side Platforms used for the aggregation and delivery of a plurality of media content to the I-HUB platform. For the purpose herein, and not by limitation, the term SSP will be used to represent the supply side providers, authors, content creators, supply side platforms or simply “suppliers”. Suppliers use the I-HUB for storage and repository services, veracity testing and market testing as well as posting content availability directly on the veracity exchange. Media content stored, tested, and sold or licensed may be accomplished through manual media content uploads or automatically by at least one SSP Application Programming Interface (API). Uploaded media content may be uploaded directly or through the platforms API interface. Media content is stored via the content supplier's platform repository interface [4200].

Referring again to FIG. 9, uploaded media content is forwarded to the Content Exchange and Repository Engine [4400]. The stored content may undergo subsequent analysis by the veracity prediction engine [4500] to further qualify the media content for ownership purchase, licensing, or publication. When the content undergoes analysis [4500], one or more supply side seller's may be presented with an analysis report or in one embodiment the report may be called a “Reliability Score”. The report enables the supplier to understand how the content compares to other similar media content. In addition, one or more of the many sellers from the supply side may use the analysis to gain insights on the quality and veracity of their media content verses similar on-line media content.
The analysis insights may be referenced or displayed to other exchange members prior to media content distribution, which may also be called publication, postings or listings of the media content. In addition, once the media content is listed for sale or licensing on the veracity exchange platform, buyer members may bid for ownership or licensing rights of the media content listed. Bidding maybe manually input or automated using one or more Demand Side Platforms (DSP). Media content listed for sale or license on the media exchange may receive online “Bids” from individual buyers, publishers, content distribution networks, and Demand Side Providers (DSPs), also known as media content “buyers” as illustrated in FIG. 9 block [4900]. Accepted bids, managed by the method, result in media content ownership and/or content use licenses between one or more “seller” members of the exchange and one or more “buyer” members on the veracity exchange platform. Accepted bids, also termed “closed bids” or “winning bids” are further process by the Licensing & Digital Currency Engine [4700] also known as the “smart contracts engine”. The smart contracts engine tracks transactions between buyer's and seller's acting as a registry for closed transactions. In one embodiment, smart contracts may use a block-chain technology for the smart registry. In an alternate embodiment, smart contracts are managed and maintained within the I-HUB repository. In yet another embodiment, the smart contracts may be operated by a third-party registry or by application programming interface. The licensing engine interfaces to the both the content seller's platform [4200] and content buyer's platform [4800] to manage and control the dynamic interactions of the plurality of transactions corresponding to each listing on the media exchange.

In one embodiment, the I-HUB platform may be used by publication outfits, media syndicators, social media platforms and the like as an application platform used to qualify media content prior to publication. In an Example, and not by limitation, content reviewers or subscriber's may use the I-HUB platform to notify subscribers of segments of their publications that may contain propaganda or violate publication rules. Thus, the present method also enables authors and other media content providers to modify content based on the reported notifications output from the veracity engine [4500] after media content analysis has completed. Furthermore, Social Media Networks or other distribution networks may use one or more veracity exchange APIs to automatically qualify social media subscriber or third-party media for publication. The veracity media exchange platform can determine and set flags to disqualify certain media segments within media content from posting.

Referring again to FIG. 9, at least one SSP exchange member [4000] may use the tools provided by the Content Seller's Platform [4200] as a means to qualify and set terms of sale for their up-loaded media content. The filtering tools [4200] help not only set the terms of the sale but also automate the sale of their media content on the exchange. Terms of the sale, set by the seller members, include the floor price, type of ownership or terms of license and use, market test reports and quality analysis scores, and the like typically based on analysis results from the veracity engine [4500]. Use of the SSP interface [4200] via an API enables setting general (or specific) terms and conditions that become a component of the digital licensing agreement between buyers and sellers. By allowing sellers to interface programmatically with the veracity exchange platform, the input side of the Smart Contract Engine [4700] may automatically generate the terms and conditions of the license that enable bids from the Demand Side Provider's (DSP) bidding engines. This process may repeat between a plethora of buyers and sellers to achieve completion of one or more media content licensing agreements. The content exchange and repository engine [4400] continuously updates the highest bids for content during one or more auction periods. If no bids reach the value of the floor set by the seller, then the auction is terminated and the licensing and digital currency engine [4700] doesn't register a winning bid or finalize the sale or license between the buyer and seller members of the exchange.

Referring again to FIG. 9, the input side of the Smart Contracts Engine [4700] allows the SSP to set the specific terms and conditions as required for a final license agreement between at least one SSP and at least one DSP. Similarly, the output side of the Smart Contracts Engine [4700] sets the expectations terms and conditions for the DSP buyer's side. In one embodiment the Licensing and Digital Currency Engine [4700] enables the use of crypto currency as the medium of exchange between buyers and sellers on the exchange. In any event, the license is not formalized until the payment is secured by the seller member of the exchange. In an embodiment, common paper, credit or other financial vehicles may also be use as the medium of currency exchange as known to those understanding the art of currency exchanges.

As illustrated in FIG. 9, the plurality of platform sellers [4000], also known as the Supply Side Providers (SSP), can place their media content for sale or license directly on the veracity exchange through one or more API interfaces to one or more client compute devices. Seller's may also use third-party Supply-Side Provider (DSP) partners to broker and further automate the selling and uploading of media content to the exchange. As this action takes place on the seller's side, another plurality of buyers [4900], also known as the Demand Side Partners (DSPs), can shop for available media content directly on the veracity exchange. Shopping and setting up bids directly on the veracity exchange may also be accomplished through one or more API interfaces to one or more client compute devices. Buyers may also use third party Demand Side Platform (DSP) partners to broker and further automate the buying and downloading of media content from the exchange. The Content Buyer's Platform [4800] interfaces to both the smart contracts block [4700] and the veracity engine [4500] for content license verification, content veracity summaries, fraud, and propaganda notifications. The media content buyers may use the veracity engine [4500] to validate that the content has authenticity, has or has not been pulled from derivative works from other sources, and in general can be used for trust and transparency verification to understand better estimations of the purchase value. The buyer analysis of media content value can be prior to enabling the bidding engine programming [4800] and establishing a winning bid price scenario. In addition, buyers may use the veracity engine analysis to understand insights of market responses and similar content already in circulation prior to purchasing. Thus, buyers or licensees of media content use the veracity exchange platform to determine content value, content quality and content validity prior to enabling their bidding strategy using the I-HUB platforms “bidding and licensing support tools” [4800] interface. For winning bidders, the winning bid price, the media content seller, buyer, terms and conditions are input to the exchanges licensing & digital currency engine for issuance of a smart contract. Registration for the winning bid transaction may then conclude for license or purchase from one or more seller members to one or more buyer members on the exchange.

Again, referring to FIG. 9, block [4400] illustrates the preferred method of combining a marketplace content exchange with a media content repository. The content exchange component manages online auction transactions between a plurality of media content providers [4000] and media content buyers [4900]. Further, block [4400] shows the programming for a media content repository used as data store for a plurality of media content owned by one or more exchange members. The media content repository enables providers to store media content, whether finished or still in work, and store media content listed for sale or license in a public or private domain. In addition, the media repository is used as an endpoint for buyers and sellers alike as well as other third-parties that have been granted access privileges. For example, a buyer that has purchased or licensed media content for publication and distribution may hire one or more Content Delivery Networks (CDNs) to enable scalable distribution of the media content. Furthermore, exchange subscribers may use the media content repository to store content and subsequently automatically run veracity analysis from time to time after a sale, license or publication transaction. The method includes the programming to continuously scan for similar content, build time-line analysis, measure the similarity and report content that is the same or has been altered to change the original meaning. The method enables subscribers to automatically receive reports of non-licensed similar content published without legal right to property that is protected with patents, trademarks, copyrights, or other ownership rights that are being violated. Thus, the method enables media content owners to take legal action or other actions to identify and rectify the situation.

The media exchange manages a plethora of network transactions that flow between media content suppliers and buyers. In an alternate embodiment, the I-HUB platform can manage media exchange transactions between not only SSP and DSP but SSP to SSP and DSP to DSP. For example, purchase transactions between the content provider members or, SSP and one or more individual buyers or DSPs are typical. In at least one embodiment sales and purchases between multiple SSP or DSP members is also possible. In an embodiment, the providers use the veracity exchange to author, test, and market their owned media content. In an embodiment, the individual authors and content creators may contract at least one SSP, known for the aggregation of a plurality of media content, to reduce the cost of exchange membership or cost of storage in addition to the cost of marketing services. In yet another embodiment, SSP organizations can aggregate similar media content for market response testing, insights on setting prices, and assessment of risk prior to placing media content on the veracity exchange platform.

The illustration of FIG. 9 block [4400] inputs floor pricing from the SSP for supply, while the DSP [4900] inputs bids, bids at the end of the auction period that are above the floor price are considered the closed bids, also called or winning bids. All closed bids are forwarded to the Digital Licensing Engine [4700] and the smart contracts engine, preferably using block-chain technology, issues ownership or license registration acknowledged by all parties involved in the exchange transaction. In addition, content to be licensed or content under investigation to be licensed may be referenced by the Content Exchange Repository [4400] for analysis under request of either the Content Sellers Platform [4200] or the Content Buyers Platform [4800] based on the input terms and conditions referenced by respective Supply Side or Demand Side Providers.

One embodiment of the method illustrated in FIG. 9, without limitation, is illustrated in detail in FIG. 10. Referring now to FIG. 10, block [5010], the programming and process flow for the I-HUB veracity exchange operation may be further illustrated starting with the programming for media content creators. Media content creators are the originators of the media content that is uploaded and stored on the veracity exchange platform. Content may be created for eventual sale or licensing or be uploaded for paid or free distribution. In one embodiment, the original authors or creators of the media content may be employed by the publishers, content distribution or syndication networks. Original authors may also be freelance creators, bloggers or influencers and the like. In one embodiment, the I-HUB veracity exchange platform serves the purpose of checking content veracity and testing content for quality and legal rights of ownership. In another embodiment, a license may be issued to protect the content from piracy or pirated derivative distribution. In yet another embodiment, the media exchange may issue zero-dollar licenses for the purpose of ownership, content tracking and distribution rights. In addition, the veracity exchange platform may be a tool to determine fraudulent ownership from one or more bootlegged derivatives originating from the original media content. Furthermore, the veracity media exchange includes it's own fraudulent detection programming. For example, in the case where a listing never closes but, soon after the same or similar media content is found in circulation by the veracity engine, the publisher, owner or content syndication network that published the content may be fraudulent and pulled the listed media content from the I-HUB repository without properly licensing. Such actions, once validated, will suspend the fraudulent member and place them on the fraudulent buyer list. In an embodiment, the original authors may be independent contractors or independent authors that wish to license their original media to publishers or media distribution channels for market credibility and monetary gain. When independent authors finalize their content, just prior to full network distribution, they may use the I-HUB veracity exchange platform to; (i) check content veracity against other similar media content [5020] determined to be similar by the veracity engine pipeline, and (2) post the media content [5020] on the I-Hub exchange for potential licensing or sale of ownership to one or more buyers. Content creators may also use the veracity exchange platform to qualify newly created media content against other similar articles to help determine if the content is original or if it has embedded similar media content from current or previous distributions. In addition, through methods like crowd sourcing, the veracity engine pipeline analysis helps the original authors to understand how the content will be received by the market prior to the sale and licensing, thus increasing the value of the media content prior to distribution. The content creator may decide that the reliability or “I-Trust” score is not good enough [5030] and may decide to use the content analysis output response to tune the media content for more specific market entry points. Thus, as illustrated in programming block [5030] if the media content is determined to not be sufficient, the process continues back to block [5010] for further refinement or abandonment by the media content creator. If the results of the reliability score [5030] are acceptable, the method continues to program block [5040] where the media content may be packaged for storage and posting via the I-HUB repository [4400]. Packaging the media content may be defined as the process of setting the selling attributes for the media content prior to posting the content for sale or license onto the I-HUB exchange. After determination that the media content is correctly packaged [5050], multiple bidding acceptance prices and/or price tiers may be set and locked associated with each media content up for sale or license. The content may then be priced and ready for posting and subsequent bid acceptance or denial on the I-HUB exchange. Once posted, media content buyers [5130] may bid against one-another for content ownership, exclusive/non-exclusive licensing, and distribution rights as describe in detail below.

Continuing with FIG. 10 programming block [5120], media content is posted to the I-HUB repository and bidding is enabled. Potential buyers or potential licensee's [5120] can now set up bidding parameters. In the preferred embodiment a plurality of Demand Side Platforms (DSPs) via the DSP API automatically sees new media content listings, determines a criteria match, sets the bidding parameters, and submits automated bids to the veracity exchange platform. The bidding process, as known to one knowledgeable in the art will accept bids for a predetermined auction period looking for the highest bidder to find and secure a fair price for the posted media content.

Referring again to FIG. 10, block [5130] illustrates the method for one or more media content buyers. Media content buyers are looking to own or obtain licensing rights to specific content for future publication on one or more content distribution channels and/or syndication networks. The buyer types may include Publishers, Content distribution channels, media syndication networks or others that wish to license content exclusively for ownership, licensing and/or network distribution. Block [5140] illustrates the programming used to enable media content buyers [5130] to programmatically set the terms and conditions of an automated buying process on the I-HUB exchange. Buying, selling, and validating veracity of media content makes up the primary method of the preferred embodiment of the I-HUB media exchange. A primary process of the method sets the terms and conditions of bidding on content listings, including but not limited to, min/max bid prices and transaction purchase or license attributes [5140]. Bidding attributes are automatically or manually determined and may be from either the exchange listing members, buying members or both. Bidding attributes from the seller may be automated by analysis results from the veracity prediction engine. For example, listing media content for sale and showing high-quality content with no propaganda or misinformation, a minimum number of similar content sightings, may enable the seller to set a higher floor price. Listings may contain sellers bidding attributes that are automatically generated, by the platform's veracity prediction engine, or manually entered prior to the time of listing. Bidding attributes from the seller may include the bidding floor price, licensing terms, main topic, media content summation analysis, veracity analysis, counts of media content with the same or similar content meaning segments and the like. Bidding attributes set by the buyer member may include, but are not limited to, setting purchase minimums and maximums, setting content no-bid restrictions based on flags like region, nationality, bias, lean and propaganda, content creator ratings, topics, or other criteria. Bidding attributes are also used by one or more APIs to automate the transactions on the exchange. The APIs have programming that, based on the outcome of the veracity content attribute flags, can start, cancel, or nullify bidding transactions automatically. In one embodiment, the buyer's criteria [5140] may be based on the results of veracity engine analysis results run by the veracity exchange prior to bidding for media content on the exchange. By checking content quality and value and setting buyer bidding attributes the bidding price range and criteria for no-bids may be set. The analysis of one or more pieces of media content helps buyers determine where and at what level to set the bidding floors and ceilings. As illustrated by the programming code of block [5150] the method of the present invention may determine media content matches that align with at least one of the buyer's requirements as indicated in the bidding attributes list [5140]. Based on the number of matches and the proximity of content to the desired content [5160] the process may continue with more refinement [5150] to include even more specific content and thus matching most of the desirable attributes. In one embodiment further scrubbing of the media [5170] may include notifications of fraudulent content. In another embodiment notifications may indicate the media content has already been licensed and may respond with at least one additional licensee or owner of the content. In yet another embodiment the analysis may notify one or more similar media content and may include additional information and similar attributes for each similar media content found. Thus, initial assessment of the content quality and the determination of purchase value may be further enhanced by using the veracity engine to identify fraudulent ownership or similar content derivatives and/or misleading information contained within the media content.

If the analysis of the media content shows misleading information, multiple similar derivative content, fraudulent or pilfered content or shows any of the attributes to never start, cancel or stop the bidding process as illustrated in block [5180] the process of FIG. 10 may result in a “No-BID” status to the content media exchange [5190] and further the process may notify the buyer through a reporting of the analysis. In an embodiment the “No-bid” result of the veracity exchange platform may automatically reject any further bidding from one source and subsequently move to another media content provider for further analysis of alternate or similar content. Thus, for one or more reasons, if the result of buyer notification [5190] stops any additional bidding for the content the bidding stops, and the platform may continue by bidding on other source provider media content [5130].

If the process of block [5180] has found no reasons to stop the bidding from the buyer due to one or more positive veracity engine results, the bidding begins [5120] starting with the floor bid amount and continues to the ceiling bid amount to secure a bid amount that enables buyer's ownership and/or licensing rights to the seller's media Content. When the bid price matches (within specified bidding windows) the sellers bid acceptance attributes the bidding is closed and a winner is declared. Block [5110] of FIG. 10 illustrates the required programming code process to enable the method when a bid is closed on the I-HUB exchange. Assuming a closed bid, the next step in the method of the preferred embodiment is to validate those funds are received [5090] and generate and register the ownership or licensing of the media content and all content rights associated with the sale. In the preferred embodiment, registration of ownership or licensing rights uses a public Block-Chain technology method to register one or more smart contracts between the buyer and seller. The use of public block chain for registration permits anyone to validate the ownership or license rights of the content of the buyer [5070]. In addition, the registration also enables a public registry that then shows the license or sales history of the media content. In the preferred embodiment once the content has completed the bidding and smart contract registration process the smart contract is established and funds for purchase may be distributed to the sellers and media content deeds or license terms are distributed to the publishers as indicated in block [5130] completing the smart contract agreement and media content exchange transactions.

What is claimed is:

1. A method for identifying embedded propaganda in media content prior to engaging in media content sales transactions on a media exchange platform, the method comprising:
uploading, from one of a plurality of exchange member client devices, a plurality of main media content to be listed on the exchange;
storing the main media content in a media content repository;
extracting a plurality of components from the main media content;
preprocessing main and similar components into content segment vectors;
applying content segment vectors to the veracity prediction engine to build a plurality of veracity indicators;
identifying, from veracity indicators, pointers to the locations within the media content wherein, one or more identified content segments contain embedded propaganda;

2. The method of claim 1, wherein, identified content segments containing embedded propaganda are displayed to one or more media exchange members on a plurality of client devices.

3. The method of claim 1, wherein, identified content segment locations containing embedded propaganda within the main or similar media content, are displayed to one or more media exchange members.

4. The method of claim 1, wherein, the media content is listed for sale or license and;
Buyer members s bidding transactions are nullified due to one or more media content components indicating embedded propaganda are identified within the listed media content.

5. The method of claim 1, wherein, social media applications use APIs to automatically qualify and disable subscriber and third-party social media publications due to the identification of embedded propaganda.

6. A method for identifying media content with the same or similar content segments to the main media content, the method comprising:
uploading, from one of a plurality of exchange member client devices, a plurality of main media content to be listed on the exchange;
storing the main media content in a media content repository;
extracting a plurality of components from the main media content;
determining key attributes segments required to find and retrieve similar media content;
searching for and retrieving media content that is the same or similar to the main media content;
extracting from the retrieved same or similar media content a plurality of components;
preprocessing the plurality of components into content segment vectors;
applying content segment vectors to the veracity prediction engine to build a plurality of veracity indicators;
identifying, from veracity indicators, pointers to the locations within the media content wherein, one or more identified content segments have the same or similar meaning when compared to the repositories stored main media content.

7. The method of claim 5, wherein, identified content segments are displayed to one or more media exchange members.

8. The method of claim 5, wherein, identified content segment locations are displayed to one or more media exchange members.

9. The method of claim 5, wherein, a count indicating the total number of times the content segments were found in the plurality of retrieved same or similar media content.

10. The method of claim 8, wherein, Sales transaction are nullified when a predetermined threshold of content segments with the same meaning are found in the totality of same and similar media content components retrieved.

11. The method of claim 5, wherein, a URL location pointer enables a hyperlink to one or more locations of same or similar media content;

12. A method for automatically determining the main media content attributes prior to listing media content on the veracity exchange platform, the method comprising:
uploading a plurality of media content to the media content repository;
preprocessing the uploaded media content into content segment vectors;
extracting a plurality of components from the media content;
applying the uploaded media content to the veracity engine for analysis;
Adding the veracity engine analysis results to the media content bidding attributes;
Posting one or more bidding attributes in the media content listing.

13. The method of claim 11, wherein, bidding attributes are added to the media content listings displayed on a plurality of exchange member client devices.

14. The method of claim 11, wherein one of the bidding attributes includes the minimum acceptable media content floor price required to gain ownership or license rights to the listed media content.

15. The method of claim 11, wherein, bidding attributes are used to qualify listed media content prior to placing bids on the media exchange platform.

16. The method of claim 11, wherein, based on the bidding attributes or results from the veracity prediction engine, the bidding manager may nullify and discontinue further bidding for media content listings on the exchange.

17. The method of claim 11, wherein, the results from analysis of the main content from one or more main media content listings determines the minimum and maximum floor pricing for the bidding process.

18. A method to identify licensing and ownership validity for a plurality of media content traded on the veracity media exchange, the method comprising:
use of a registry to uniquely register and identify listed and sold media content; registration uses block-chain technology to track media content entities and distribution time-lines;
winning buyers, pay the sellers according to the winning bidder rules in a timely manner;
content ownership and distribution rights transfer through the media exchange platform.

19. The method of claim 17, wherein, properly owned, or licensed media content improves the quality score ratings for the owners and licensees of the media content.

20. The method of claim 17, wherein, properly owned, or licensed media content improves the quality rating of the content of the media content.

21. The method of claim 17, wherein, fraudulent members are added to a list of non-trusted members which is distributed to all members of the media exchange platform.

22. The method of claim 5, wherein, listed but not sold main media content that is identified during one or more same or similar media content searches is identified and reported to the original listing member.

23. The method of claim 21, wherein, if identified but not sold media content has been released for distribution by one of the veracity exchange members other than the seller member, the seller member is considered a fraudulent member of the veracity media exchange.

24. A method of using APIs to automatically enable real-time sales listings and bidding process for the main media segment vectors stored in the repository of the exchange, the method comprising:
a plurality of SSP and DSP exchange members running one or more APIs;
applying stored segment vectors for the main and similar media content to the veracity engine;
Automatically determining from the veracity engine analysis, the listing and bidding attributes;
Applying the bidding attributes in real-time to enable the content exchange platform to start the buyer and seller media exchange transactions.

25. The method of claim 23, wherein, flags identified within the listing or bidding content attributes, nullifies starting the buyer and seller media exchange transactions.
